(19) United States
(12) Patent Application Publication
(10) Pub. No.: US 2023/0148097 A1
(43) Pub. Date: May 11, 2023

(54) ADVERSE ENVIRONMENT DETERMINATION DEVICE AND ADVERSE ENVIRONMENT DETERMINATION METHOD

(71) Applicant: DENSO CORPORATION, Kariya-city (JP)

(72) Inventor: MASATO MIYAKE, Kariya-city (JP)

(21) Appl. No.: 18/150,094

(22) Filed: Jan. 4, 2023

Related U.S. Application Data
(63) Continuation of application No. PCT/JP2021/025362, filed on Jul. 5, 2021.

(30) Foreign Application Priority Data
Jul. 7, 2020 (JP) 2020-117247

(51) Int. Cl. G06V 20/56; G06T 7/70; G06V 10/74

(52) U.S. Cl. CPC G06V 20/588; G06T 7/70; G06V 10/761; G06T 2207/30256

(57) ABSTRACT

An adverse environment determination device includes: an environment determination unit that is configured to determine, based on the recognition result of the target planimetric feature acquired by the image recognition information acquisition unit, whether a surrounding environment of the vehicle is an adverse environment for a device that is configured to perform object recognition using the image captured by the imaging device; and a recognition distance evaluation unit that is configured to determine, based on the image recognition information, an actual recognition distance that is an actual distance within which the target planimetric feature is actually recognized.

### CROSS REFERENCE TO RELATED APPLICATIONS

This application is a continuation application of International Patent Application No. PCT/JP2021/025362 filed on Jul. 5, 2021, which designated the U.S. and claims the benefit of priority from Japanese Patent Application No. 2020-117247 filed on Jul. 7, 2020. The entire disclosure of all of the above application is incorporated herein by reference.

### TECHNICAL FIELD

The present disclosure relates to a technique for determining whether an environment is an adverse environment for a device that recognizes an object by using image data captured by an on-board camera.

### BACKGROUND ART

In recent years, various techniques have been proposed for recognizing the surrounding environment using image data captured by an on-board camera and proposed for use in vehicle control such as collision damage mitigation braking, self-position estimation, or the like. For example, there has been known a technique for specifying a position of a vehicle based on an observation position of a landmark recognized on the bases of a captured image from a front camera and based on position coordinates of a landmark registered in map data, as a technique for specifying a position of a vehicle with higher accuracy. A process of specifying a position of a vehicle by collating (that is, matching) image recognition results of a front camera and map data in this way is also called a localization process.

### SUMMARY

One aspect of the present disclosure is an adverse environment determination device including: an image recognition information acquisition unit that is configured to acquire, as image recognition information, information indicative of a recognition result of a target planimetric feature, the recognition result being determined by analyzing an image captured by an imaging device that is configured to capture the image of a predetermined range of surroundings of a vehicle; an environment determination unit that is configured to determine, based on the recognition result of the target planimetric feature acquired by the image recognition information acquisition unit, whether a surrounding environment of the vehicle is an adverse environment for a device that is configured to perform object recognition using the image captured by the imaging device; and a recognition distance evaluation unit that is configured to determine, based on the image recognition information, an actual recognition distance that is an actual distance within which the target planimetric feature is actually recognized. The target planiemetric feature includes a lane defining line. The recognition distance evaluation unit is configured to calculate the actual recognition distance for the lane defining line. The environment determination unit is configured to: determine that the surrounding environment is the adverse environment when the actual recognition distance for the lane defining line is shorter than a predetermined threshold; and determine a type of the adverse environment based on the actual recognition distance for the lane defining line upon determining that the surrounding environment is the adverse environment.

### BRIEF DESCRIPTION OF DRAWINGS

FIG. 1 is a block diagram showing a configuration of a driver-assistance system.

FIG. 2 is a block diagram showing a configuration of a front camera.

FIG. 3 is a functional block diagram showing a configuration of an environment determiner.

FIG. 4 is a functional block diagram showing a configuration of a position estimator.

FIG. 5 is a flowchart of an adverse environment determination process.

FIG. 6 is a diagram for describing a first distance used for determining whether an environment is an adverse environment.

FIG. 7 is a flowchart of an adverse environment type determination process.

FIG. 8 is a diagram summarizing a correspondence relationship between a recognition status for each planimetric feature and the type of the environment.

FIG. 9 is a flowchart showing a modification of the adverse environment type determination process.

FIG. 10 is a block diagram showing a configuration of the environment determiner 20.

FIG. 11 is a flowchart of a road surface condition determination process.

FIG. 12 is a block diagram showing a modification of an environment determination unit.

FIG. 13 is a diagram showing a modification of a system configuration.

FIG. 14 is a diagram showing a modification of a system configuration.

FIG. 15 is a diagram showing a modification of a system configuration.

FIG. 16 is a diagram showing an overall configuration of a map distribution system.

FIG. 17 is a flowchart for describing an operation of a map server.

### DESCRIPTION OF EMBODIMENTS

To begin with, a relevant technology will be described first only for understanding the following embodiment.

A typical localization process is based on the premise that a camera can accurately recognize a landmark. However, in the adverse environment such as rainfall or dense fog, the camera image becomes blurred, thereby a landmark recognition success rate of the camera may be reduced. In particular, the more distant a landmark is located, the more difficult it becomes to recognize the landmark. Not only the landmark, the object recognition function of the on-board camera may be reduced in the adverse environment such as rainfall or dense fog.

The accuracy and performance of image recognition greatly contributes to the safety of autonomous driving. Therefore, it is desired to specify a point that is in the adverse environment for a device that recognizes an object by using image data, in other words, a point where an image becomes blurred, in order to improve the convenience or safety of a user.

The present disclosure has been made based on the above situation, and one objective of the present disclosure is to provide an adverse environment determination device and an adverse environment determination method capable of specifying a point that is an adverse environment for a device that recognizes an object by using image data.

A first aspect of the present disclosure is an adverse environment determination device including: an image recognition information acquisition unit that is configured to acquire, as image recognition information, information indicative of a recognition result of a target planimetric feature, the recognition result being determined by analyzing an image captured by an imaging device that is configured to capture the image of a predetermined range of surroundings of a vehicle; an environment determination unit that is configured to determine, based on the recognition result of the target planimetric feature acquired by the image recognition information acquisition unit, whether a surrounding environment of the vehicle is an adverse environment for a device that is configured to perform object recognition using the image captured by the imaging device; and a recognition distance evaluation unit that is configured to determine, based on the image recognition information, an actual recognition distance that is an actual distance within which the target planimetric feature is actually recognized. The target planiemetric feature includes a lane defining line. The recognition distance evaluation unit is configured to calculate the actual recognition distance for the lane defining line. The environment determination unit is configured to: determine that the surrounding environment is the adverse environment when the actual recognition distance for the lane defining line is shorter than a predetermined threshold; and determine a type of the adverse environment based on the actual recognition distance for the lane defining line upon determining that the surrounding environment is the adverse environment.

A second aspect of the present disclosure is an adverse environment determination device including: an image recognition information acquisition unit that is configured to acquire, as image recognition information, information indicative of a recognition result of a target planimetric feature, the recognition result being determined by analyzing an image captured by an imaging device that is configured to capture the image of a predetermined range of surroundings of a vehicle; an environment determination unit that is configured to determine, based on the recognition result of the target planimetric feature acquired by the image recognition information acquisition unit, whether a surrounding environment of the vehicle is an adverse environment for a device that is configured to perform object recognition using the captured image; and a recognition distance evaluation unit that is configured to determine, based on the image recognition information, an actual recognition distance that is an actual distance within which the target planimetric feature is actually recognized. The target planiemetric feature includes a landmark. The recognition distance evaluation unit is configured to calculate the actual recognition distance for the landmark. The environment determination unit is configured to: determine that the surrounding environment is the adverse environment when the actual recognition distance for the landmark is shorter than a predetermined threshold; and determine a type of the adverse environment based on the actual recognition distance for the landmark upon determining that the surrounding environment is the adverse environment.

A third aspect of the present disclosure is an adverse environment determination device including: an image recognition information acquisition unit that is configured to acquire, as image recognition information, information indicative of a recognition result of a target planimetric feature, the recognition result being determined by analyzing an image captured by an imaging device that is configured to capture the image of a predetermined range of surroundings of a vehicle; an environment determination unit that is configured to determine, based on the recognition result of the target planimetric feature acquired by the image recognition information acquisition unit, whether a surrounding environment of the vehicle is an adverse environment for a device that is configured to perform object recognition using the captured image; and a recognition distance evaluation unit that is configured to determine, based on the image recognition information, an actual recognition distance that is an actual distance within which the target planimetric feature is actually recognized. The target planiemetric feature includes both a lane defining line and a landmark. The recognition distance evaluation unit is configured to calculate the actual recognition distance for the lane defining line and the actual recognition distance for the landmark. The environment determination unit is configured to: determine that the surrounding environment is the adverse environment when at least one of the actual recognition distance for the lane defining line and the actual recognition distance for the landmark is shorter than a predetermined threshold; and determine a type of the adverse environment based on the actual recognition distance for the lane defining line and the actual recognition distance for the landmark upon determining that the surrounding environment is the adverse environment.

A fourth aspect of the present disclosure is an adverse environment determination device including: an image recognition information acquisition unit that is configured to acquire, as image recognition information, information indicative of a recognition result of a target planimetric feature, the recognition result being determined by analyzing an image captured by an imaging device that is configured to capture the image of a predetermined range of surroundings of a vehicle; an environment determination unit that is configured to determine, based on the recognition result of the target planimetric feature acquired by the image recognition information acquisition unit, whether a surrounding environment of the vehicle is an adverse environment for a device that is configured to perform object recognition using the captured image; and a supplementary information acquisition unit that is configured to acquire, as supplementary environment information, information indicative of an outside environment of the vehicle from a sensor other than the imaging device. The target planimetric feature includes both a lane defining line and a landmark. The supplementary information acquisition unit is configured to acquire at least one of a traveling direction of the vehicle, time information, and an altitude of the sun. The environment determination unit is configured to: determine whether the surrounding environment of the vehicle is the adverse environment based on the recognition result of the target planimetric feature acquired by the image recognition information acquisition unit and the supplementary environment information acquired by the supplementary information acquisition unit; and determine a type of the adverse environment upon determining that the surrounding environment is the adverse environment. The environment determination unit is further configured to: determine whether a predetermined afternoon sun condition is satisfied based on the information acquired by the supplementary information acquisition unit; and determine that the surrounding environment is an afternoon sun situation as the adverse environment when the afternoon sun condition is satisfied and the lane defining line away from the vehicle by a predetermined distance or more is recognized but a predetermined type of the landmark or the landmark present in a predetermined direction is not recognized.

A fifth aspect of the present disclosure is an adverse environment determination device, including: an image recognition information acquisition unit that is configured to acquire, as image recognition information, information indicative of a recognition result of a target planimetric feature, the recognition result being determined by analyzing an image captured by an imaging device that is configured to capture the image of a predetermined range of surroundings of a vehicle; an environment determination unit that is configured to determine, based on the recognition result of the target planimetric feature acquired by the image recognition information acquisition unit, whether a surrounding environment of the vehicle is an adverse environment for a device that is configured to perform object recognition using the captured image; and a supplementary information acquisition unit that is configured to acquire, as supplementary environment information, information indicative of an outside environment of the vehicle from a sensor other than the imaging device. The target planimetric feature includes both a lane defining line and a landmark. The supplementary information acquisition unit is configured to acquire at least one of an outside air temperature, a humidity, time, and a current position. The environment determination unit is configured to: determine whether the surrounding environment of the vehicle is the adverse environment based on the recognition result of the target planimetric feature acquired by the image recognition information acquisition unit and the supplementary environment information acquired by the supplementary information acquisition unit; and determine a type of the adverse environment upon determining that the surrounding environment is the adverse environment. The environment determination unit is further configured to: determine whether a predetermined fog condition is satisfied based on the information acquired by the supplementary information acquisition unit; and determine that the type of the adverse environment is fog when the fog occurrence condition is satisfied and the lane defining line and the landmark that are located within a predetermined distance from the imaging device are recognized.

A sixth aspect of the present disclosure is an adverse environment determination device including: an image recognition information acquisition unit that is configured to acquire, as image recognition information, information indicative of a recognition result of a target planimetric feature, the recognition result being determined by analyzing an image captured by an imaging device that is configured to capture the image of a predetermined range of surroundings of a vehicle; an environment determination unit that is configured to determine, based on the recognition result of the target planimetric feature acquired by the image recognition information acquisition unit, whether a surrounding environment of the vehicle is an adverse environment for a device that is configured to perform object recognition using the captured image; and a supplementary information acquisition unit that is configured to acquire, as supplementary environment information, information indicative of an outside environment of the vehicle from a sensor other than the imaging device. The target planimetric feature includes both a lane defining line and a landmark. The supplementary information acquisition unit is configured to acquire at least one of a humidity, an operation speed of a windshield wiper, and weather information. The environment determination unit is configured to: determine whether the surrounding environment of the vehicle is the adverse environment based on the recognition result of the target planimetric feature acquired by the image recognition information acquisition unit and the supplementary environment information acquired by the supplementary information acquisition unit; and determine a type of the adverse environment upon determining that the surrounding environment is the adverse environment. The environment determination unit is further configured to: determine whether a predetermined heavy rainfall condition is satisfied based on the information acquired by the supplementary information acquisition unit; and determine that the type of the adverse environment is heavy rainfall when the heavy rainfall condition is satisfied and both the lane defining line and the landmark that are away from the imaging device by a predetermined distance or more are not recognized.

For example, at a point that becomes an adverse environment such as rainfall or fog for a device that recognizes an object by using image data, a distance within which a planimetric feature can be recognized may decrease compared to a good environment, such as fine weather. That is, the image recognition result of the planimetric feature is used for functioning as an indicator of whether an environment is an adverse environment. The present disclosure is created by focusing on the property described above, and according to the above configuration, it is determined whether an environment is an adverse environment for a device (for example, a camera) that recognizes an object by using an image based on the actual recognition status of a predetermined planimetric feature. According to such a configuration, it is possible to specify a point where the performance of object recognition may actually be reduced.

A seventh aspect of the present disclousure is an adverse environment determination method executed by at least one processor for determining whether a surrounding environment of a vehicle is an adverse environment for a device that is configured to perform object recognition using an image. The adverse environment determination method includes: acquiring, as image recognition information, information indicative of a recognition result of a target planimetric feature including at least a lane defining line, the image recognition result being determined by analyzing an image captured by an imaging device that is configured to capture the image of a predetermined range of surroundings of a vehicle; calculating, based on the image recognition information, an actual recognition distance that is an actual distance within which the lane defining line is actually recognized; determining that the surrounding environment is the adverse environment when the actual recognition distance for the lane defining line is shorter than a predetermined threshold; determining a type of the adverse environment based on the actual recognition distance for the lane defining line upon determining that the surrounding environment is the adverse environment.

A eighth aspect of the present disclosure is an adverse environment determination method executed by at least one processor for determining whether a surrounding environment of a vehicle is an adverse environment for a device that is configured to perform object recognition using an image. The adverse environment determination method includes: acquiring, as image recognition information, information indicative of a recognition result of a target planimetric feature including a landmark, the image recognition result being determined by analyzing an image captured by an imaging device that is configured to capture the image of a predetermined range of surroundings of a vehicle; determining, based on the image recognition information, an actual recognition distance that is an actual distance within which the landmark is actually recognized; determining that the surrounding environment is the adverse environment when the actual recognition distance for the landmark is shorter than a predetermined threshold; and determining a type of the adverse environment based on the actual recognition distance for the landmark upon determining that the surrounding environment is the adverse environment.

According to an adverse environment determination method for achieving the purpose, it is possible to specify a point that is an adverse environment for a device that recognizes an object by using image data, based on the same operation principle as the adverse environment determination device.

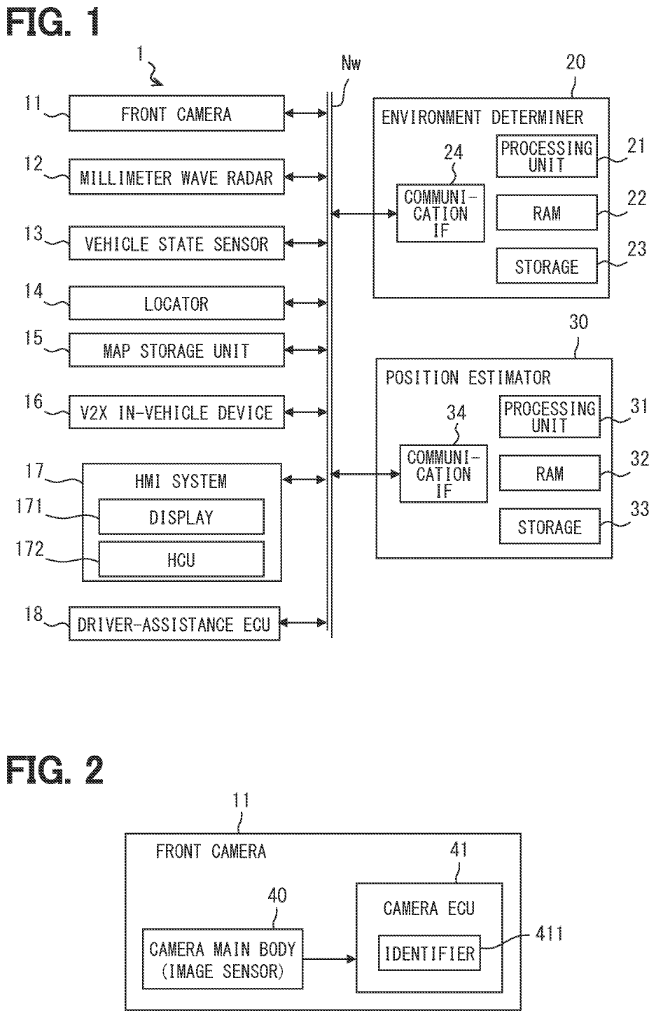

Next, one embodiment of the present disclosure will be described below with reference to the drawings. FIG. 1 is a diagram showing an example of a schematic configuration of a driver-assistance system 1 to which a position estimator of the present disclosure is applied.

<Overview of Overall Configuration>

As shown in FIG. 1, the driver-assistance system 1 includes a front camera 11, a millimeter wave radar 12, a vehicle state sensor 13, a locator 14, a map storage unit 15, a V2X in-vehicle device 16, an HMI system 17, a driver-assistance ECU 18, an environment determiner 20, and a position estimator 30. The ECU in the member name is an abbreviation for Electronic Control Unit and means an electronic control device. The HMI is an abbreviation for Human Machine Interface. The V2X is an abbreviation for Vehicle to X (Everything) and refers to a communication technique used for connecting various things to a vehicle.

The various devices or sensors that configure the driver-assistance system 1 are connected as nodes to an in-vehicle network Nw, which is a communication network built inside the vehicle. Nodes that are connected to the in-vehicle network Nw can communicate with each other. Specific devices may be configured to be able to communicate directly with each other without going through the in-vehicle network Nw. For example, the environment determiner 20 and the position estimator 30 may be directly and electrically connected to each other by a dedicated line. Although the in-vehicle network Nw is configured as a bus type in FIG. 1, the present disclosure is not limited thereto. A network topology may be a mesh type, a star type, a ring type, or the like. A network shape is changeable as appropriate. As the standard of the in-vehicle network Nw, it is possible to adopt various standards such as Controller Area Network (hereinafter, CAN: registered trademark), Ethernet (Ethernet is a registered trademark), FlexRay (registered trademark), and the like.

Hereinafter, a vehicle on which the driver-assistance system 1 is mounted is also described as a subject vehicle, and an occupant seated in a driver's seat of the subject vehicle (that is, an occupant in the driver's seat) is also described as a user. Each direction of front-rear, horizontal, and vertical directions in the following description is defined with reference to the subject vehicle. Specifically, the front-rear direction corresponds to the longitudinal direction of the subject vehicle. The horizontal direction corresponds to the width direction of the subject vehicle. The vertical direction corresponds to the height direction of the vehicle. From another point of view, the vertical direction corresponds to a direction perpendicular to a plane parallel to the front-rear direction and the horizontal direction.

<Overview of Each Configuration Element>

The front camera 11 is a camera that images the front side of the vehicle at a predetermined angle of view. The front camera 11 is disposed, for example, at an upper end portion of a front windshield inside the vehicle, a roof top, or a front grille. As shown in FIG. 2, the front camera 11 includes a camera main body 40 that generates an image frame, and a camera ECU 41 that detects a predetermined detection target object by performing recognition processing on the image frame. The camera main body 40 is configured to include at least an image sensor and a lens. The camera main body 40 generates and outputs captured image data at a predetermined frame rate (for example, 60 fps). The camera ECU 41 is mainly composed of an image processing chip including a Central Processing Unit (CPU) or a Graphics Processing Unit (GPU). The camera ECU 41 includes an identifier 411 as a functional block. The identifier 411 is configured to identify the type of an object based on the feature amount vector of an image generated by the camera main body 40. For the identifier 411, for example, it is possible to use a Convolutional Neural Network (CNN) or a Deep Neural Network (DNN), to which deep learning is applied. The identifier 411 corresponds to an example of an object recognition unit.

A detection target object of the front camera 11 includes, for example, a moving object such as a pedestrian or another vehicle. The other vehicle includes a bicycle, a motorized bicycle, or a motorcycle. The front camera 11 is configured to be able to detect a predetermined planimetric feature. The planimetric feature, which is used as a detection target for the front camera 11, includes a road edge, a road surface marking, or a structure installed along the road. The road surface marking refers to paint drawn on the road surface for traffic control and traffic regulation. For example, the road surface marking includes a lane defining line indicating a lane boundary, a pedestrian crossing, a stop line, a traffic lane, a safety zone, or a regulation arrow. The lane defining line is also called a lane mark or a lane marker. The lane defining line also includes things realized by road studs such as chatter bars and botts' dots. In the following description, the term “lane marking” refers to a boundary line between lanes. A roadway outer line, a center line, or the like can be included in the lane marking.

For example, a structure installed along the road includes a guard rail, a curb, a tree, a utility pole, a traffic sign, and a traffic light. An image processor that forms the camera ECU 41 separates and extracts a background and the detection target object from the captured image based on image information including color, luminance, contrast related to color or brightness, or the like.

A part or all of the planimetric features, which are used as detection targets for the front camera 11, are used as landmarks in the position estimator 30. The landmark in the present disclosure refers to a planimetric feature that can be used as a mark for specifying the position of the subject vehicle on the map. That is, it is possible to adopt at least one of a signboard corresponding to a traffic sign such as a regulation sign, a guide sign, a warning sign, and an instruction sign, a traffic light, a pole, and an information plate as the landmark. The guide sign refers to a direction signboard, a signboard indicating an area name, a signboard indicating a road name, a notice signboard for announcing a gateway of an expressway, a service area, or the like. A streetlight, a mirror, a utility pole, a commercial advertisement signboard, a signboard indicating a store name, an iconic building such as a historic building, or the like can be included in the landmark. The pole also includes a streetlight or a utility pole. An undulating portion and cave-in portion of a road, a manhole, a joint portion, or the like can be included in the landmark. An end point or branch point of the lane marking also can be used as a landmark. It is possible to change the types of planimetric features used as the landmark as appropriate. A road edge, a lane marking, or the like can also be included in the landmark. As the landmark, it is preferable to adopt a planimetric feature such as a traffic light or a direction signboard that does not change with time and that has a magnitude that allows image recognition even from a point 100 m or more away.

A planimetric feature, among the landmarks, that can be used as a mark for estimating a position in the longitudinal direction of the vehicle (hereinafter, longitudinal position estimation) is also referred to as a longitudinal position estimation-landmark. The longitudinal direction here corresponds to the front-rear direction of the vehicle. The longitudinal direction corresponds to the road extension direction, which is a direction in which the road extends as viewed from the subject vehicle, in a straight road segment. As the longitudinal position estimation-landmark, for example, it is possible to adopt the map element that is discretely disposed along the road and to adopt the map element with little change over time, such as a traffic sign such as a direction signboard, or a road surface marking such as a stop line. A planimetric feature, among the landmarks, that can be used as a mark for estimating a position in the lateral direction of the vehicle (hereinafter, lateral position estimation) is also referred to as a lateral position estimation-landmark. The lateral direction here corresponds to the width direction of the road. The lateral position estimation-landmark refers to a planimetric feature that is present continuously along the road, such as a road edge or a lane marking. The front camera 11 may be configured to be able to detect a planimetric feature of the type set as the landmark.

The camera ECU 41 calculates a relative distance and a direction from the vehicle of the planimetric feature such as a landmark and a lane marking, from an image including Structure from Motion (SfM) information. A relative position (the distance and the direction) of the planimetric feature with respect to the subject vehicle may be specified based on the magnitude or posture (for example, an inclination level) of the planimetric feature in the image. The camera ECU 41 is configured to be able to identify the type of the landmark such as whether it is a direction signboard or not, based on the color, the magnitude, the shape, or the like of the landmark being recognized. The lane defining line or the landmark corresponds to a target planimetric feature.

The camera ECU 41 generates traveling road data indicating the shape of the traveling road, such as curvature or width, based on the positions and shapes of the lane defining line and the road edge. The camera ECU 41 calculates a yaw rate based on the SfM. The camera ECU 41 sequentially provides the position estimator 30 or the driver-assistance ECU 18 with detection result data indicating the relative position, the type, or the like of the detected object via the in-vehicle network Nw. Hereinafter, expressions such as the position estimator 30 and the like refer to at least one of the position estimator 30, the environment determiner 20, and the driver-assistance ECU 18.

As a more preferable aspect, the camera ECU 41 of the present embodiment also outputs data indicating the reliability of the image recognition result. The reliability of the recognition result is calculated based on, for example, the amount of rainfall, the presence or absence of backlight, the brightness of the outside, and the like. The reliability of the recognition result may be a score indicating a matching level of the feature amount. The reliability may be, for example, a probability value indicating the certainty of the recognition result output as the identification result by the identifier 411. The probability value may correspond to the matching level of the feature amount described above. The reliability of the recognition result may be an average value of the probability values for each detected object generated by the identifier 411.

The camera ECU 41 may evaluate the reliability of the recognition result based on the stability of the identification result with respect to the same tracked object. For example, the reliability may be evaluated as high when the identification result of the type of the same object is stable, and the reliability may be evaluated as low when a tag for the type as the identification result with respect to the same object is unstable. A state in which the identification result is stable refers to a state in which the same result is continuously obtained. A state in which the identification result is unstable refers to a state in which the same result is not obtained continuously, such as the identification result changing over and over again.

The millimeter wave radar 12 is a device that transmits a probe wave such as a millimeter wave or a quasi-millimeter wave toward the front of the vehicle and that detects the relative position and relative speed of an object with respect to the subject vehicle by analyzing the reception data of a reflected wave that the transmission wave is reflected by the object and returned. For example, the millimeter wave radar 12 is installed in a front grille or a front bumper. The millimeter wave radar 12 incorporates a radar ECU that identifies the type of the detected object, based on the magnitude, a travel speed, and reception strength of the detected object. As a detection result, the radar ECU outputs data indicating the type, the relative position (direction and distance), and the reception strength of the detected object to the position estimator 30 or the like. The detection target object of the millimeter wave radar 12 also includes the above-mentioned landmarks.

The front camera 11 and the millimeter wave radar 12 may be configured to provide observation data used for object recognition to the driver-assistance ECU 18 via the in-vehicle network Nw. For example, the observation data for the front camera 11 refers to an image frame. The observation data of the millimeter wave radar refers to the data indicating the reception strength and the relative speed for each detection direction and distance, or the data indicating the relative position and reception strength of the detected object. The observation data corresponds to raw data observed by the sensor or data before executing the recognition processing.

Object recognition processing based on the observation data may be executed by the ECU outside the sensor, such as the driver-assistance ECU 18. The calculation of the relative position of the landmark may also be performed by the position estimator 30, the driver-assistance ECU 18, or the like. A part of the functions of the camera ECU 41 and the millimeter wave radar 12 (mainly an object recognition function) may be provided in the position estimator 30 or the driver-assistance ECU 18. In this case, the camera as the front camera 11 or the millimeter wave radar may provide the position estimator 30 or the driver-assistance ECU 18 with the observation data such as image data and distance measurement data as detection result data.

The vehicle state sensor 13 is a sensor that detects a state amount related to traveling control of the subject vehicle. For example, the vehicle state sensor 13 includes an inertial sensor such as a three-axis gyro sensor and a three-axis acceleration sensor. The three-axis acceleration sensor is a sensor that detects each of the accelerations acting on the subject vehicle in the front-rear, horizontal, and vertical directions. The gyro sensor detects a rotation angular velocity around a detection axis, and the three-axis gyro sensor has three detection axes orthogonal to each other. The inertial sensor corresponds to a sensor that detects a physical state amount that indicates the behavior of the vehicle that is produced as a result of the driving operation of the occupant in the driver's seat or the control by the driver-assistance ECU 18. Various sensors may be packaged as an Inertial Measurement Unit (IMU).

The driver-assistance system 1 includes an outside air temperature sensor and a humidity sensor as the vehicle state sensors 13. The driver-assistance system 1 may include an atmospheric pressure sensor or a magnetic sensor as the vehicle state sensor 13. A shift position sensor, a steering angle sensor, a vehicle speed sensor, a windshield wiper speed sensor, or the like can also be included in the vehicle state sensor 13. The shift position sensor is a sensor that detects a position of a shift lever. The steering angle sensor is a sensor that detects a rotation angle of the steering wheel (so-called steering angle). The vehicle speed sensor is a sensor that detects a traveling speed of the subject vehicle. The windshield wiper speed sensor is a sensor that detects the operation speed of the windshield wiper. The operation speed of the windshield wiper includes an operation interval.

The vehicle state sensor 13 outputs data indicating a current value of the physical state amount which is a detection target (that is, a detection result) to the in-vehicle network Nw. The output data of each vehicle state sensor 13 is acquired by the position estimator 30 or the like via the in-vehicle network Nw. The type of the sensor used by the driver-assistance system 1 as the vehicle state sensor 13 need only be designed as appropriate, and it is not necessary to include all the sensors described above. A rain sensor that detects rainfall or an illuminance sensor that detects outside brightness can be included in the vehicle state sensor 13.

The locator 14 is a device that generates highly accurate position information of the subject vehicle through complex positioning for combining multiple information. The locator 14 is configured using, for example, a GNSS receiver. The GNSS receiver is a device that sequentially detects current positions of a Global Navigation Satellite System (GNSS) receiver by receiving navigation signals transmitted from positioning satellites forming the GNSS. For example, when the GNSS receiver can receive the navigation signals from four or more positioning satellites, the GNSS receiver outputs positioning results every 100 milliseconds. As the GNSS, it is possible to adopt the GPS, the GLONASS, the Galileo, the IRNSS, the QZSS, or the Beidou.

The locator 14 sequentially measures the position of the subject vehicle by combining a positioning result of the GNSS receiver and an output of the inertial sensor. For example, when the GNSS receiver cannot receive a GNSS signal inside a tunnel, the locator 14 performs dead reckoning (that is autonomous navigation) by using a yaw rate and a vehicle speed. The yaw rate used for the dead reckoning may be calculated by the front camera 11 by using the SfM technique or may be detected by a yaw rate sensor. The locator 14 may perform dead reckoning by using the output of the acceleration sensor or the gyro sensor. The vehicle position information obtained by the positioning is output to the in-vehicle network Nw and is used by the position estimator 30 or the like.

The map storage unit 15 is a non-volatile memory that stores high accuracy map data. The high accuracy map data here corresponds to map data indicating a road structure, and a position coordinate regarding the planimetric feature disposed along the road with accuracy that can be used for autonomous driving. The high accuracy map data includes, for example, three-dimensional shape data of the road, lane data, or planimetric feature data. The three-dimensional shape data of the road described above includes node data related to a point (hereinafter, referred to as a node) at which multiple roads intersect, merge, or branch, and link data related to the road (hereinafter, referred to as a link) connecting the points.

The link data indicates the shape and configuration of the road. The link data includes road edge information indicating position coordinates of the road edge, road width information, or the like. The link data may include data indicating a road type such as whether the road is a motorway or a general road. The motorway here refers to a road on which the pedestrian or the bicycle is prohibited from entering, such as a toll road such as an expressway. The link data may include attribute information indicating whether autonomous traveling is allowed on the road.

The lane data indicates the number of lanes, installation position information of the lane marking for each lane, a traveling direction for each lane, and a branching or merging point in a lane level. The lane data may include, for example, information indicating which pattern of solid lines, dashed lines, and botts' dots are used for the lane markings. The position information about the lane marking or the road edge (hereinafter referred to as the lane marking, or the like) is expressed as a coordinate group (that is, a point group) of points where the lane defining lines are formed. As another aspect, the position information such as the lane marking may be represented by a polynomial expression. The position information such as the lane marking may be a collection of line segments represented by a polynomial expression (that is, a line group).

The planimetric feature data includes a position and type information of the road surface marking such as a stop line, or a position, a shape, and type information of the landmark. As described above, the landmark includes a three-dimensional structure installed along the road, such as a traffic sign, a traffic light, a pole, and a commercial signboard. The map storage unit 15 may be configured to temporarily store high accuracy map data within a predetermined distance from the subject vehicle. The map data stored in the map storage unit 15 may be navigation map data, which is map data for navigation. The navigation map data is lower in accuracy than the high accuracy map data and corresponds to map data with a smaller amount of information about road shapes than the high accuracy map data. When the navigation map data includes planimetric feature data such as a landmark, it is possible to replace the following expression such as a “high accuracy map” with a navigation map. As described above, the landmark here refers to a planimetric feature, such as a traffic sign, used for subject vehicle position estimation, that is, a localization process.

The V2X in-vehicle device 16 is a device for the subject vehicle to perform wireless communication with other devices. The “V” of V2X indicates an automobile serving as the subject vehicle, and the “X” indicates various presences other than the subject vehicle, such as the pedestrian, other vehicles, a road facility, the network, or the server. The V2X in-vehicle device 16 includes a wide area communication unit and a short range communication unit as communication modules. The wide area communication unit is a communication module for performing wireless communication conforming to a predetermined wide area wireless communication standard. As the wide area wireless communication standard here, it is possible to adopt various standards, such as Long Term Evolution (LTE), 4G, or 5G. The wide area communication unit may be configured to be able to execute wireless communication directly with other devices, in other words, without going through the base station, by a method compliant with the wide area wireless communication standard, in addition to communication via a wireless base station. That is, the wide area communication unit may be configured to execute cellular V2X. The subject vehicle is a connected car that can be connected to the Internet by mounting the V2X in-vehicle device 16. For example, it is possible for the position estimator 30 to download the latest high accuracy map data from a predetermined map server and to update the map data stored in the map storage unit 15 in cooperation with the V2X in-vehicle device 16.

The short range communication unit provided in the V2X in-vehicle device 16 is a communication module for directly performing wireless communication with other moving objects or roadside devices that are present surroundings of the subject vehicle in a mode that complies with the short range communication standard according to a communication standard in which a communication distance is limited within several hundred meters. The other moving objects are not limited to the vehicle and may include the pedestrian or the bicycle. As the short range communication standard, it is possible to adopt any desired standard such as the Wireless Access in Vehicular Environment (WAVE) standard disclosed in IEEE 1609 or the Dedicated Short Range Communications (DSRC) standard.

The HMI system 17 is a system that provides an input interface function for accepting a user operation and an output interface function for presenting information to the user. The HMI system 17 includes a display 171 and an HMI Control Unit (HCU) 172. As means of presenting the information to the user, it is possible to adopt a speaker, a vibrator, or an illumination device (for example, an LED), in addition to the display 171.

The display 171 is a device that displays an image. For example, the display 171 is a center display provided in an uppermost portion of a central part of the instrument panel in the vehicle width direction. The display 171 can perform a full-color display and can be realized by using a liquid crystal display, an organic light emitting diode (OLED) display, a plasma display, or the like. As the display 171, the HMI system 17 may include a head-up display that projects a virtual image on a portion of the front windshield in front of the driver's seat. The display 171 may be a meter display.

The HCU 172 is configured to comprehensively control information presentation to the user. The HCU 172 is realized by using a processor such as a CPU and a GPU, a RAM, or a flash memory. The HCU 172 controls a display screen of the display 171, based on information provided from the driver-assistance ECU 18 or a signal from an input device (not illustrated). For example, the HCU 172 displays a deceleration notification image on the display 171 based on a request from the position estimator 30 or the driver-assistance ECU 18.

The driver-assistance ECU 18 is an ECU that assists a driving operation of the occupant in the driver's seat, based on the detection results of the surrounding monitoring sensors such as the front camera 11 and the millimeter wave radar 12 or the map information stored in the map storage unit 15. For example, the driver-assistance ECU 18 executes a part or all of the driving operation on behalf of the occupant in the driver's seat by controlling the traveling actuator based on the detection result of the surrounding monitoring sensor and the map information stored in the map storage unit 15. The traveling actuator refers to an actuator related to the traveling control such as acceleration, deceleration, or turning. For example, a braking device, an electron throttle, a steering actuator, or the like corresponds to the traveling actuator. The driver-assistance ECU 18 may be an automatic operation device that causes the subject vehicle to autonomously travel based on a user's input of an autonomous traveling instruction. The driver-assistance ECU 18 mainly includes a computer provided with a processor, a RAM, a storage, a communication interface, a bus connecting these, and the like. Each element is omitted in the illustration. The driver-assistance ECU 18 may be configured to change the operation, in other words, the system response, in response to the output signal indicating the determination result of the environment determiner 20. For example, when the environment determiner 20 outputs a signal indicating that the surrounding environment is an adverse environment for the front camera 11, the vehicle-to-vehicle distance may be made longer than usual, or a message indicating that the image recognition performance is reduced may be displayed for the occupant in the driver's seat.

The environment determiner 20 is configured to determine whether the surroundings of the vehicle are the adverse environment for a device that recognizes an object by using image data captured by the on-board camera. The adverse environment, as used herein, includes an environment in which sharpness of an image produced by the on-board camera is reduced. A state in which the sharpness of the image is reduced includes a state in which the image is blurred. As an example in the present disclosure, the environment determiner 20 is configured to determine whether the surroundings of the vehicle are the adverse environment for the front camera 11. Details of the function of the environment determiner 20 will be described separately later. The environment determiner 20 is mainly composed of a computer including a processing unit 21, a RAM 22, a storage 23, a communication interface 24, and a bus connecting them. The processing unit 21 is hardware for calculation processing combined with the RAM 22. The processing unit 21 is configured to include at least one arithmetic core such as a CPU. The processing unit 31 executes various processes by accessing the RAM 22. The storage 23 is configured to include a non-volatile storage medium such as a flash memory. The storage 23 stores an environment determination program, which is a predetermined program executed by the processing unit 21. Execution of the environment determination program by the processing unit 21 corresponds to execution of an adverse environment determination method corresponding to the environment determination program. The communication interface 24 is a circuit for communicating with other devices via the in-vehicle network Nw. The communication interface 24 need only be implemented by using an analog circuit element, an IC, or the like. The environment determiner 20 corresponds to the adverse environment determination device. The environment determiner 20 may be realized as a chip (for example, SoC: System-on-a-Chip).

The position estimator 30 is configured to specify the current position of the subject vehicle. Details of the function of the position estimator 30 will be described separately later. The position estimator 30 is mainly composed of a computer including a processing unit 31, a RAM 32, a storage 33, a communication interface 34, and a bus connecting them. The processing unit 31 is hardware for calculation processing combined with the RAM 32. The processing unit 31 is configured to include at least one arithmetic core such as a CPU. The processing unit 31 executes various processes for realizing an ACC function or the like by accessing the RAM 32. The storage 33 includes a non-volatile storage medium, such as a flash memory. The storage 33 stores a position estimation program, which is a predetermined program executed by the processing unit 31. Execution of the position estimation program by the processing unit 31 corresponds to execution of a position estimation method corresponding to the position estimation program. The communication interface 34 is a circuit for communicating with other devices via the in-vehicle network Nw. The communication interface 34 may be realized by using an analog circuit element or an IC.

<Regarding Environment Determiner 20>

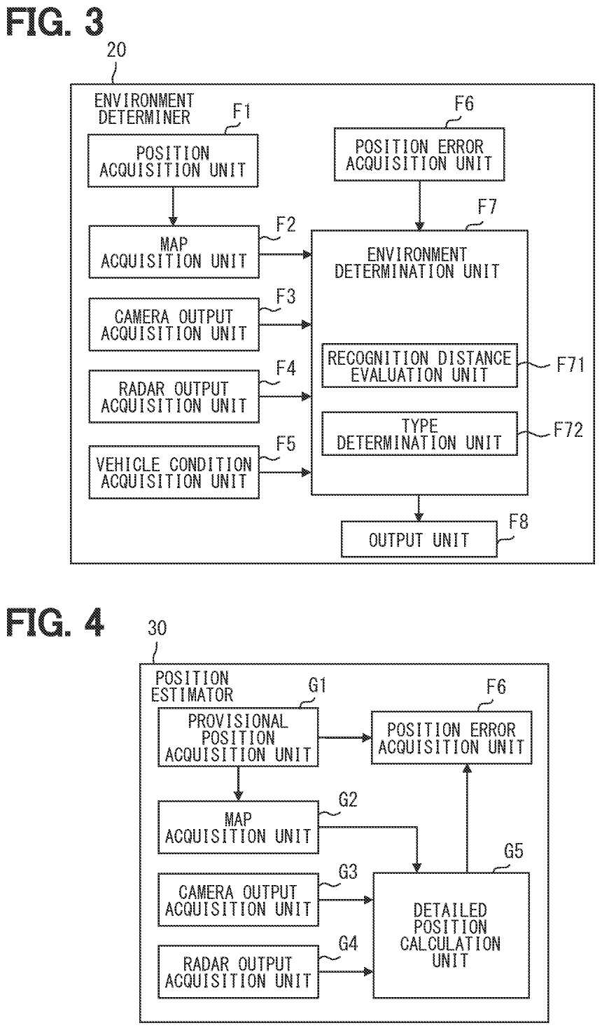

A function and an operation of the environment determiner 20 will be described with reference to FIG. 3. The environment determiner 20 provides functions corresponding to various functional blocks shown in FIG. 3 by executing the environment determination program stored in the storage 23. That is, the position estimator 30 includes, as functional blocks, a position acquisition unit F1, a map acquisition unit F2, a camera output acquisition unit F3, a radar output acquisition unit F4, a vehicle condition acquisition unit F5, a position error acquisition unit F6, and an environment determination unit F7.

The position acquisition unit F1 acquires position information of the subject vehicle output by the position estimator 30. The position acquisition unit F1 may be configured to acquire the subject vehicle position information from the locator 14.

The map acquisition unit F2 reads map data in a predetermined range defined based on the current position from the map storage unit 15. As the current position that is used for map reference, it is possible to adopt a position that is specified by either the locator 14 or a detailed position calculation unit G5 described later. For example, when the detailed position calculation unit G5 can calculate the current position, the detailed position calculation unit G5 acquires map data by using the position information. On the other hand, when the detailed position calculation unit G5 cannot calculate the current position, the detailed position calculation unit G5 acquires the map data by using the position coordinates calculated by the locator 14. On the other hand, immediately after the traveling power supply is turned on, for example, a map reference range is determined based on the previous position calculation result stored in the memory. The reason is that the previous position calculation result, which is stored in the memory, corresponds to the end point of the previous trip, that is, the parking position. The map acquisition unit F2 may be configured to sequentially download high accuracy map data for areas within a predetermined distance from the subject vehicle from an external server or the like via the V2X in-vehicle device 16. The map information acquired by the map acquisition unit F2 preferably includes topography information such as a plain area, a basin, and a mountain area. The basin here refers to the flat land surrounded by the mountain, and the plain area refers to the flat land other than the basin. The mountain area refers to an area between mountains. The mountain area can be defined as a place relatively narrower than a basin, a place of higher altitude, or a trough. By acquiring the information as to whether the place corresponds to a basin or a mountain area, it becomes possible to determine whether fog is likely to be generated in the place.

The camera output acquisition unit F3 acquires a recognition result of the front camera 11 with respect to a landmark, a road edge, and a lane defining line. For example, the camera output acquisition unit F3 acquires a relative position, a type, color, and the like of the landmark, which is recognized by the front camera 11, from the front camera 11, actually from the camera ECU 41. When the front camera 11 is configured to be able to extract a character string added to a signboard or the like, it is preferable to also acquire character information written on the signboard or the like. The reason is that, according to the configuration in which the character information of the landmark can be acquired, it becomes easy to associate the landmark, which is observed by the front camera, with the landmark on the map. The camera output acquisition unit F3 corresponds to an image recognition information acquisition unit.

The camera output acquisition unit F3 also converts the relative position coordinates of the landmark acquired from the camera ECU 41 into position coordinates (hereinafter also referred to as observation coordinates) in the global coordinate system. It is possible to calculate the observation coordinates of the landmark by combining the current position coordinates of the subject vehicle and the relative position information of the planimetric feature with respect to the subject vehicle. When the detailed position calculation unit G5 can calculate the current position, the position information may be used as the current position coordinates of the vehicle used to calculate the observation coordinates of the landmark. On the other hand, when the detailed position calculation unit G5 cannot calculate the current position, the position coordinates calculated by the locator 14 may be used. The camera ECU 41 may calculate the observation coordinates of the landmark using the current position coordinates of the subject vehicle.

The camera output acquisition unit F3 acquires traveling road data from the front camera 11. That is, the relative position of the lane marking or the road edge recognized by the front camera 11 is acquired. The camera output acquisition unit F3 may convert the relative position information of the lane marking or the like into position coordinates in the global coordinate system in the same manner as the landmarks. The data acquired by the camera output acquisition unit F3 is provided to the environment determination unit F7.

The radar output acquisition unit F4 acquires a recognition result of the millimeter wave radar 12. For example, the radar output acquisition unit F4 acquires the relative position information of the landmark detected by the millimeter wave radar 12, from the millimeter wave radar 12. Alternatively, the reflection intensity for each landmark may be acquired. The radar output acquisition unit F4 may acquire the magnitude of the unnecessary reflected electric power observed by the millimeter wave radar 12, in other words, a noise level. The radar output acquisition unit F4 is any element. The detection data of the millimeter wave radar 12 acquired by the radar output acquisition unit F4 is provided to the environment determination unit F7. The radar output acquisition unit F4 corresponds to the distance measuring sensor information acquisition unit. When the driver-assistance system 1 includes LIDAR, the radar output acquisition unit F4 may acquire the detection result of the LIDAR. The LIDAR is a device that generates three-dimensional point group data indicating positions of reflection points for each detection direction by irradiation of the laser light. The LIDAR stands for Light Detection and Ranging/Laser Imaging Detection and Ranging.

The vehicle condition acquisition unit F5 acquires information as a material for determining whether the surrounding environment is the adverse environment, such as a traveling direction, the outside air temperature, the humidity outside the cabin, the time information, the weather, the road surface condition, the windshield wiper operation speed, or the like, from the vehicle state sensor 13 or the like via the in-vehicle network Nw. The traveling direction refers to an azimuth angle in which the vehicle is facing. The time information may be, for example, Universal Time, Coordinated (UTC), or may be time information of the standard country of the area where the vehicle is used. When the UTC is acquired, a time difference is corrected and used for the subsequent process. The weather refers to sunny, rain, snow, or the like. The weather preferably includes weather information from the present to a predetermined time (for example, 1 hour) as well as weather information for a predetermined time (for example, 3 hours) in the past from the present. The reason is that rainfall, snowfall, or the like in the past may influence the road surface condition or the recognition performance of the lane marking or the like recognized by the front camera 11. It is preferable that the air temperature information also includes not only the current temperature, but also temperature information for a predetermined time in the past from the present, particularly temperature information at dawn. The reason is that fog is more likely to occur as the temperature difference from dawn increases. By making it possible to calculate the temperature difference from dawn, it is possible to improve the accuracy of determining whether the condition for fog occurrence is satisfied.

The output signals, which are from the front camera 11 or the millimeter wave radar, or the map information described above also correspond to materials for determining whether the surrounding environment is the adverse environment. The vehicle condition acquisition unit F5 is configured to acquire, from the vehicle state sensor 13 or the like, materials for determination other than the detection result of the surrounding monitoring sensor and the map information. The acquisition source such as the road surface condition, the outside air temperature, or the weather information, is not limited to the vehicle state sensor 13. The road surface condition, the outside air temperature, the weather information, or the like may be acquired from an external server or a roadside device via the V2X in-vehicle device 16. The rainfall condition may be detected by a rain sensor.

The position error acquisition unit F6 acquires a position estimation error from the position estimator 30 and provides the acquired position estimation error to the environment determination unit F7. The position estimation error will be described separately later.

The environment determination unit F7 is configured to determine whether the surrounding environment of the subject vehicle corresponds to an environment that may reduce the performance, in other words, accuracy, of the object recognition using the image frame generated by the front camera 11. That is, the environment determination unit F7 is configured to determine whether the surrounding environment is the adverse environment for the front camera 11. For example, the environment determination unit F7 executes an adverse environment determination process, which will be described later, based on the fact that the position estimation error provided from the position estimator 30 is equal to or greater than a predetermined threshold. The environment determination unit F7 includes, as sub-functions, a recognition distance evaluation unit F71 and a type determination unit F72. Each function included in the environment determination unit F7 is not an essential element, and any element may be used.

The recognition distance evaluation unit F71 calculates an actual recognition distance, which is a distance range in which the front camera 11 can actually recognize the landmark. The actual recognition distance is a parameter that varies due to external factors such as fog, rainfall, or afternoon sun, unlike a designed recognition limit distance. Even when the designed recognition limit distance is substantially 100 m, it may decrease to less than 50 m depending on the amount of rainfall. For example, during heavy rainfall, the actual recognition distance may decrease to substantially 20 m. The recognition distance evaluation unit F71 calculates the actual recognition distance based on the farthest recognition distance for at least one detected landmark, for example, within a predetermined time. The farthest recognition distance is a distance at which the same landmark can be detected from the farthest point. A distance from a landmark, at a time point when a previously undetected landmark is detected as the subject vehicle moves, corresponds to the farthest recognition distance for that landmark. When the farthest recognition distances for multiple landmarks are obtained, it is possible to define the actual recognition distance as an average value thereof, a maximum value, or a second largest value. For example, when the farthest recognition distances of four landmarks observed within the most recent predetermined time are 50 m, 60 m, 30 m, and 40 m, the actual recognition distance may be calculated as 45 m. The farthest recognition distance for a certain landmark corresponds to the detection distance at a time point at which the landmark can be detected for the first time. The actual recognition distance may be the maximum value of the farthest recognition distance observed within the most recent predetermined time. The landmarks here are mainly assumed to be planimetric features such as signboards that are discretely disposed, in other words, scattered along the road.

The actual recognition distance of the landmark may be reduced by factors other than weather, such as occlusion by a preceding vehicle. Therefore, when a preceding vehicle is present within the predetermined distance, the calculation of the actual recognition distance may be omitted. Alternatively, when a preceding vehicle is present, the actual recognition distance may be provided to the environment determination unit F7 by adding data indicating the presence of the preceding vehicle (for example, a preceding vehicle flag). When the front side of the subject vehicle is not a straight line, that is, when the road is a curved road, the actual recognition distance may also be reduced. Therefore, when the road ahead is curved, the calculation of the actual recognition distance may be omitted. Further, when the road ahead is curved, the actual recognition distance may be provided to the environment determination unit F7 in association with data (for example, a curve flag) indicating that the road ahead is curved. The curved road is assumed to have a curvature of a predetermined threshold value or more.

When multiple types of planimetric features are set as the landmarks, the landmarks used by the recognition distance evaluation unit F71 to calculate the actual recognition distance may be limited to some types. For example, the landmarks used to calculate the actual recognition distance may be limited to high-altitude landmarks such as direction signboards, which are landmarks disposed above the road surface by a predetermined distance (for example, 4.5 m) or more. By limiting the landmarks used to calculate the actual recognition distance to the high-altitude landmarks, it is possible to prevent the actual recognition distance from being reduced due to other vehicles blocking the field of view.

The recognition distance evaluation unit F71 also calculates the actual recognition distance with respect to the lane defining line. The actual recognition distance for the lane defining line corresponds to information indicating how far the road surface can be recognized. It is possible to determine the actual recognition distance of the lane marking, for example, based on a distance to the most distant detection point among the detection points of the lane markings. The lane marking, which is used to calculate the actual recognition distance, is preferably a lane marking on the left or right side or both sides of an ego lane that is a lane where the subject vehicle travels. The reason is that there is a possibility that the outside lane marking of the adjacent lane will be blocked by other vehicles. It is possible to define the actual recognition distance of the lane marking as, for example, an average value of the recognition distances within the most recent predetermined time period. The actual recognition distance of such a lane marking corresponds to, for example, a movement average value of the recognition distances. According to the configuration using the movement average value as the actual recognition distance of the lane marking, it is possible to reduce instantaneous fluctuations in the recognition distance caused by another vehicle blocking the lane marking.

The recognition distance evaluation unit F71 may separately calculate the actual recognition distance with respect to the right lane marking and the actual recognition distance to the left lane marking of the ego lane. In that case, it is possible to adopt the larger one of the actual recognition distance of the right lane marking and the actual recognition distance of the left lane marking, as the actual recognition distance of the lane marking. According to such a configuration, even in a situation where either the left or right lane marking cannot be seen due to a curve or preceding vehicle, it is possible to accurately evaluate how far the front camera 11 can recognize the lane marking. The average value of the actual recognition distance of the right lane marking and the actual recognition distance of the left lane marking may be adopted as the actual recognition distance of the lane marking. The recognition distance evaluation unit F71 may also calculate the actual recognition distance with respect to the road edge in the same manner as for the lane defining line.

The type determination unit F72 is configured to determine the type of the adverse environment. The adverse environment can be substantially classified into heavy rainfall, fog, afternoon sun, and others. The types of environment are substantially classified into an adverse environment and a normal environment. The details of the type determination unit F72 will be described separately later.

The output unit F8 is configured to output a signal indicating the determination result of the environment determination unit F7 to the outside. The determination result of the environment determination unit F7 includes whether the environment corresponds to the adverse environment, the type of the adverse environment, the determination time, and the like. Determining that the environment is not the adverse environment corresponds to determining that the environment is the normal environment. For example, as an output destination of the signal indicating the determination result of the environment determination unit F7, the position estimator 30, the driver-assistance ECU 18, the V2X in-vehicle device 16, or the like may be used. The output unit F8 may be configured to cooperate with the V2X in-vehicle device 16 and upload a communication packet, which includes information about a point where a determination is made to be the adverse environment, to a map server. The determination result of the environment determination unit F7 may be configured to be output to an operation recording device that records vehicle data when a predetermined recording event occurs. According to such a configuration, the operation recording device can record whether the surrounding environment is the adverse environment, together with the point information or the time information.

<Regarding Function of Position Estimator 30>

A function and an operation of the position estimator 30 will be described with reference to FIG. 4. The position estimator 30 provides functions corresponding to various functional blocks shown in FIG. 4 by executing the position estimation program stored in the storage 33. That is, the position estimator 30 includes, as functional blocks, a provisional position acquisition unit G1, a map acquisition unit G2, a camera output acquisition unit G3, a radar output acquisition unit G4, and a detailed position calculation unit G5.

The provisional position acquisition unit G1 acquires the position information of the subject vehicle from the locator 14. Dead reckoning is performed based on the output of a yaw rate sensor or the like with the position calculated by the detailed position calculation unit G5 as a start point. A part or all of the functions of the locator 14 may be included in the position estimator 30 as the provisional position acquisition unit G1. The map acquisition unit G2, the camera output acquisition unit G3, and the radar output acquisition unit G4 may have the same configuration similar to those of the map acquisition unit F2, the camera output acquisition unit F3, and the radar output acquisition unit F4 included in the environment determiner 20.

The detailed position calculation unit G5 executes a localization process based on the landmark information and the traveling road information acquired by the camera output acquisition unit F3. The localization process refers to a process of specifying a detailed position of the subject vehicle by collating the position of the landmark or the like specified based on the image captured by the front camera 11 and the position coordinates of the planimetric feature registered in the high accuracy map data.

Specifically, the detailed position calculation unit G5 performs longitudinal position estimation by using the landmark such as a direction signboard. As the longitudinal position estimation, the detailed position calculation unit G5 associates the landmark, which is registered on the map, with the landmark, which is observed by the front camera 11, based on the observation coordinates of the landmark. For example, among the landmarks registered on the map, the landmark closest to the observation coordinates of the landmark is estimated to be the same landmark. When collating the landmarks, it is preferable to adopt landmarks with a higher matching level of the feature, using feature amounts such as shape, size, and color. When the association between the landmark being observed and the landmark on the map is completed, a longitudinal position of the subject vehicle on the map is set at a position shifted to a near side by a distance between the observation landmark and the subject vehicle from the position of the landmark on the map corresponding to the observation landmark. The near side refers to a direction opposite to the traveling direction of the subject vehicle. When the subject vehicle is traveling forward, the near side corresponds to the rear side of the vehicle.

For example, in a situation where a distance to the direction signboard in front of the subject vehicle is specified as 100 m as an image analysis result, it is determined that the subject vehicle is present at a position shifted to the near side by 100 m from the position coordinates of the direction signboard registered in the map data. The longitudinal position estimation corresponds to a process of specifying the position of the subject vehicle in the road extension direction. The longitudinal position estimation may also be referred to as the localization process in the longitudinal direction. By performing such longitudinal position estimation, a feature point on the road such as an intersection, a curved entrance or exit, a tunnel entrance or exit, a tail end of the traffic congestion, in other words, the detailed remaining distance to the POI is specified.

For example, when multiple landmarks (for example, direction signboards) are detected on the front side of the subject vehicle, the detailed position calculation unit G5 uses the landmark, of the multiple landmarks, closest to the subject vehicle and performs the longitudinal position estimation. Regarding the accuracy of recognizing a type or a distance of an object based on an image or the like, the recognition accuracy increases as the object is closer to the vehicle. That is, when multiple landmarks are detected, it is possible to improve the estimation accuracy of the position by providing a configuration of performing the longitudinal position estimation by using the landmark closest to the vehicle.

The detailed position calculation unit G5 may specify the position of the landmark by complementarily combining the recognition result of the front camera 11 and the detection result of the millimeter wave radar 12 acquired by the radar output acquisition unit F4. Specifically, the detailed position calculation unit G5 may specify the distance between the landmark and the subject vehicle, and an elevation angle or height of the landmark by using both the recognition result of the front camera 11 and the detection result of the millimeter wave radar 12. In general, cameras are good at estimating positions in the horizontal direction, but not so good at estimating positions and distances in the height direction. On the other hand, the millimeter wave radar 12 is good at estimating positions in the distance or height directions. The millimeter wave radar 12 is less susceptible to the influence of fog or rainfall. According to the configuration in which the position of the landmark is estimated by using the front camera 11 and the millimeter wave radar 12 in a complementary manner as described above, it is possible to specify the relative position of the landmark with higher accuracy. As a result, the estimation accuracy of the position of the subject vehicle by the localization process is also improved. The detailed position calculation unit G5 may combine the detection result of a distance measuring sensor such as LIDAR or sonar with the recognition result of the front camera 11 instead of or in parallel with the millimeter wave radar 12 and execute the localization process. The technique of combining the outputs of multiple sensors may also be called sensor fusion. The detailed position calculation unit G5 may perform the localization process by using the result of the sensor fusion.

The detailed position calculation unit G5 performs lateral position estimation by using the observed coordinates of the planimetric feature that is continuously present along the road, such as a lane defining line and a road edge. The lateral position estimation refers to specifying the traveling lane or specifying the detailed position of the subject vehicle within the traveling lane, for example, the amount of offset in the horizontal direction from the center of the lane. The lateral position estimation is realized, for example, based on a distance from the left and right road edges or the lane marking recognized by the front camera 11. For example, when a distance from the left road edge to the center of the vehicle is specified as 1.75 m as a result of the image analysis, it is determined that the subject vehicle is present at a position shifted 1.75 m to the right from the coordinates of the left road edge. The lateral position estimation may also be referred to as the localization process in the lateral direction. As another aspect, the detailed position calculation unit G5 may be configured to perform the localization process in both the longitudinal and lateral directions by using the landmark such as a direction signboard.

The position of the subject vehicle as a result of the localization process may be represented in the same coordinate system as the map data, such as latitude, longitude, and altitude. It is possible to represent the subject vehicle position information in any absolute coordinate system such as World Geodetic System 1984 (WGS84).

As long as the front camera 11 can recognize (in other words, capture) the landmark, the detailed position calculation unit G5 sequentially performs the localization process at a predetermined position estimation cycle. A default value of the position estimation cycle is, for example, 100 milliseconds. The default value of the position estimation cycle may be 200 milliseconds or 400 milliseconds. The position information calculated by the detailed position calculation unit G5 is provided to the driver-assistance ECU 18 and the environment determiner 20.

The position error calculation unit G6 calculates, as a position estimation error, a difference between the current position output as a result of the localization process performed at the current time and a position calculated by performing dead reckoning or the like by the provisional position acquisition unit G1, each time the detailed position calculation unit G5 executes the localization process. For example, when the localization process is executed by using a different landmark than the one used previously, the position error calculation unit G6 calculates, as the position estimation error, an error between the subject vehicle position coordinates calculated by the provisional position acquisition unit G1 and the result of the localization process. The position estimation error increases as a period during which localization cannot be performed increases, and a large position error indirectly indicates the length of the period during which the localization cannot be performed. During the period when the localization process cannot be executed, by multiplying the elapsed time or the travel distance from the time point, when the localization process cannot be executed lastly, by a predetermined error estimation coefficient, it is possible to sequentially calculate a provisional position estimation error. The position estimation error that is calculated by the position error calculation unit G6 is provided to the environment determiner 20 and the like.

<Regarding Operation Flow of Environment Determiner 20>

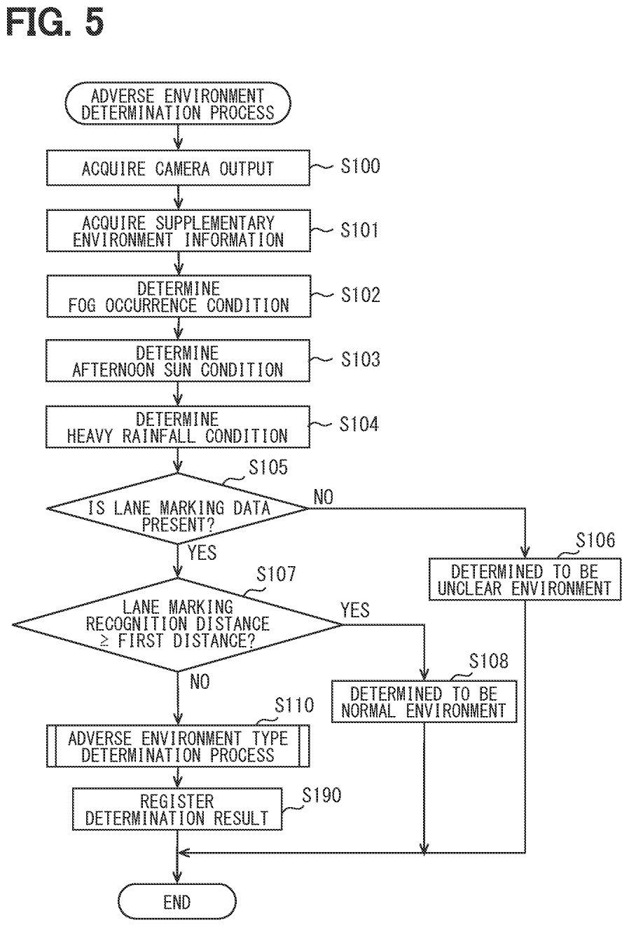

Next, the adverse environment determination process executed by the environment determiner 20 will be described with reference to the flowchart shown in FIG. 5. For example, processes in the flowchart illustrated in FIG. 5 are performed while a traveling power supply for the vehicle is turned on, at a predetermined cycle (for example, every 1 second). The traveling power supply is, for example, an ignition power supply in an engine vehicle. In an electric vehicle, a system main relay corresponds to the traveling power supply. The position estimator 30 sequentially executes the localization process at a predetermined cycle independently of the adverse environment determination process shown in FIG. 5, in other words, in parallel. In the present embodiment, as an example, the adverse environment determination process includes steps S100 to S110.

First, in step S100, the camera output acquisition unit F3 acquires the recognition result of the lane marking or the like from the front camera 11, and the process proceeds to S101. Step S100 corresponds to an image recognition information acquisition step. In S101, the map acquisition unit F2, the radar output acquisition unit F4, and the vehicle condition acquisition unit F5 acquire various supplementary environment information. The supplementary environment information here is information indicating the outside environment of the vehicle other than the output signal of the front camera 11. The supplementary environment information includes, for example, the outside air temperature, the humidity, the time information, the weather, the road surface condition, the windshield wiper operation speed, the map information about surroundings (for example, topography type), the detection result of the millimeter wave radar 12, and the like. For example, the outside air temperature, the humidity, the windshield wiper operation speed, or the like is acquired by the vehicle condition acquisition unit F5. Further, the map information about the surroundings is acquired by the map acquisition unit F2. The detection result of the millimeter wave radar 12 is acquired by the radar output acquisition unit F4. The map acquisition unit F2, the radar output acquisition unit F4, and the vehicle condition acquisition unit F5 correspond to the supplementary information acquisition unit. When various information is acquired, the process proceeds to step S102. Steps S101 and S102 may be executed sequentially as a preparatory process for the adverse environment determination process independently of the flowchart shown in FIG. 5, in other words, in parallel.

In step S102, it is determined whether the fog occurrence condition is satisfied based on the temperature or the like acquired by the vehicle condition acquisition unit F5. For example, the fog occurrence condition is a condition for fog occurrence or a condition that fog is likely to occur. The fog occurrence condition is set in advance. For example, it is possible to define the fog occurrence condition by using at least one of items of the time, the place, the outside air temperature, and the humidity. For example, (a) the air temperature is equal to or lower than a predetermined value (for example, 15° C. or lower), (b) the humidity is equal to or higher than a predetermined value (for example, 80% or more), (c) the current time belongs to the time period from 4:00 a.m. to 10:00 a.m. or the like can be defined as the fog occurrence condition. In general, fog tends to occur on sunny mornings when the wind is weak in spring or autumn. The fog occurrence condition may be set in view of the circumstances. Fog may occur in basins or mountain areas regardless of the time period. It may be determined that the fog occurrence condition is satisfied based on the fact that the current position is in a basin or a mountain area. When the fog occurrence condition is satisfied, a fog flag is set to ON. On the other hand, when the fog occurrence condition is not satisfied, the fog flag is set to OFF. The fog flag is a flag that indicates whether the fog occurrence condition is satisfied. When step S102 is completed, the process proceeds to step S103.

In step S103, it is determined whether an afternoon sun condition is satisfied based on the time information or the traveling azimuth angle acquired by the vehicle condition acquisition unit F5. For example, the afternoon sun condition is a condition for determining that there is a possibility that the front camera 11 is negatively influenced by the afternoon sun. The afternoon sun refers to light from the sun whose angle with respect to the horizon line is, for example, 25 degrees or less. The afternoon sun condition is set in advance. For example, it is possible to define the afternoon sun condition by using at least one of items of a time period, a traveling azimuth angle, and an altitude of the sun. For example, (a) the current time belongs to the time period from 3:00 p.m. to 20:00 (b) the traveling direction is within 30 degrees from the sunset direction, or the like can be defined as the afternoon sun condition.

The definition related to the time period may be configured to change according to the season. The reason is that the time of sunset varies according to the season. The time period of (a) may be from 2 hours before sunset to 30 minutes after sunset. The sunset time may be acquired from an external server by wireless communication, or the standard time for each season may be registered in the storage 23. The sunset direction may be due west or may be set in a direction according to each area. The sunset direction also changes according to the season. The sunset direction may be set to a direction according to the season. Regarding the afternoon sun condition, the afternoon sun condition may include that the altitude of the sun is equal to or lower than a predetermined value. The altitude of the sun may be estimated from the length of shadows of the surrounding vehicle or a predetermined type of the traffic sign, or may be acquired from the external server. The environment determination unit F7 may determine that the afternoon sun condition is satisfied based on the color information or luminance distribution of the entire image frame. For example, it may be determined that the afternoon sun condition is satisfied when the average color of the upper area of the image frame is white to orange and the average color of the lower area is black, or when the average brightness of the upper area is equal to or higher than a predetermined value and the average luminance value of the lower area is equal to or lower than the predetermined threshold. When the afternoon sun condition is satisfied, an afternoon sun flag is set to ON. On the other hand, when the afternoon sun condition is not satisfied, the afternoon sun flag is set to OFF. The afternoon sun flag is a flag indicating whether the afternoon sun condition is satisfied. When step S103 is completed, the process proceeds to step S104.

In step S104, it is determined whether the heavy rainfall condition is satisfied based on the operation speed of the windshield wiper acquired by the vehicle condition acquisition unit F5. For example, the heavy rainfall condition is a condition for determining whether heavy rainfall is the cause of deterioration of the recognition capability of the front camera 11. The heavy rainfall here can be defined as rain falling at a rate that the amount of rainfall per hour exceeds a predetermined threshold (for example, 50 mm). The concept of the heavy rainfall also includes localized heavy rainfall with less than an hour (for example, several tens of minutes) of rainfall at the same point. The heavy rainfall condition is set in advance. It is possible to define the heavy rainfall condition by using at least one of items of an operation speed of a windshield wiper blade, the amount of rainfall, and weather forecast information. For example, the operation speed of the windshield wiper blade is equal to or greater than a predetermined threshold can be defined as the heavy rainfall condition. It may be determined that the heavy rainfall condition is satisfied based on the amount of rainfall being equal to or greater than a predetermined threshold (for example, 50 mm), based on the weather information acquired from the external server or a roadside device. When the heavy rainfall condition is satisfied, a heavy rainfall flag is set to ON. On the other hand, when the heavy rainfall condition is not satisfied, the heavy rainfall flag is set to OFF. The heavy rainfall flag is a flag indicating whether the heavy rainfall condition is satisfied. When step S104 is completed, the process proceeds to step S105.

In step S105, based on the map data acquired by the map acquisition unit F2, it is determined whether a lane marking exists on the road on which the subject vehicle is traveling. For example, it may be determined that the lane marking is present based on the fact that the number of lanes registered on the map is two or more. When the vehicle is traveling on a road whose lane marking information is registered on the map, an affirmative determination is made in step S105, and step S107 is executed. On the other hand, when the vehicle is traveling on a road whose lane marking information is not registered on the map, a negative determination is made in step S105 and step S106 is executed. In step S106, it is determined that it is unclear whether the surrounding environment is the adverse environment, and the process flow is ended.

Step S105 may be a process of determining whether a landmark is present in the surroundings of the current position, in other words, whether the current position corresponds to a section where a landmark can be observed, based on the map data acquired by the map acquisition unit F2. Steps S105 and S106 are any elements and may be omitted. When step S104 is completed, step S107 may be executed. However, by including step S105 in the adverse environment determination process, it is possible to reduce the possibility of erroneously determining that the surrounding environment is the adverse environment for the front camera 11 even though the environment is not actually the adverse environment. By including step S105 in the adverse environment determination process, it is possible to omit the subsequent processes in a section where it is impossible for the front camera 11 to determine whether the surrounding environment is the adverse environment. As a result, it is possible to reduce the processing load on the processing unit 21.

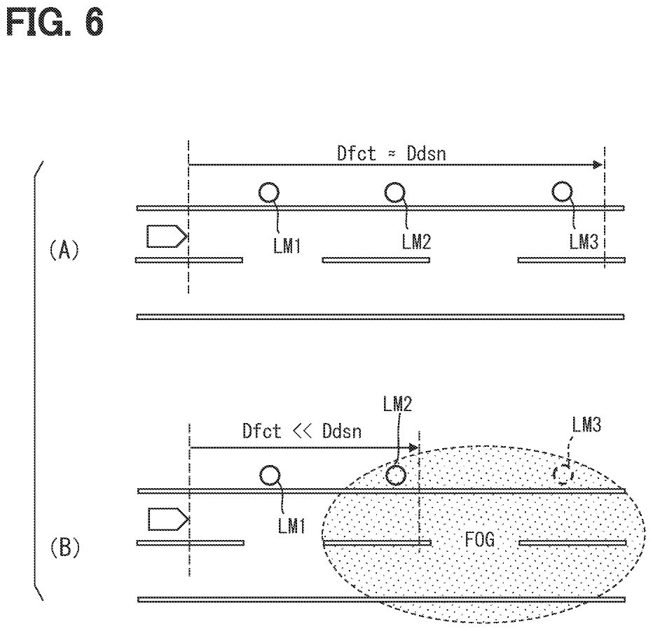

In step S107, it is determined whether the actual recognition distance to the lane marking is equal to or longer than a predetermined first distance. The first distance may be defined as, for example, 40 m or the like. The first distance is a threshold for determining whether the surrounding environment is the adverse environment. For example, in a good environment such as fine weather with clear air, the actual recognition distance Dfct of the lane marking has a value of relatively close to the designed recognition distance Ddsn as shown in (A) in FIG. 6. On the other hand, in the adverse environment such that fog occurs or the like, the more distant the planimetric feature is, the blurrier the image of the planimetric feature becomes blurred. Thus, the more distant an object is, the more difficult it becomes to recognize the object. As a result, as shown in (B) in FIG. 6, the actual recognition distance of the lane marking or the like may be reduced.

It is preferable that the environment determination unit F7 determines that the environment is not the adverse environment for the front camera 11 when the lane marking can be recognized far away as in normal times, even when it rains. The first distance may be defined as a parameter for determining that the environment is not the adverse environment when the lane marking can be recognized far away as in normal times. It is possible to set the first distance based on the actual recognition distance in a good environment such as fine weather. The first distance may be 35 m, 50 m, 75 m, 100 m, 200 m, or the like. Step S107 corresponds to a process of determining whether the lane marking distant by a first distance or more from the current position can be recognized. (A) in FIG. 6 shows a case where the landmarks LM1 to LM3 are recognized, while (B) in FIG. 6 shows a case where the landmark LM3 are not recognized due to the influence of fog. Being in fog doesn't mean not all landmarks become invisible. For example, depending on the density of the fog, the landmark LM2 relatively close to the vehicle may be recognized as shown in (B) in FIG. 6.

When the actual recognition distance of the lane marking is equal to or longer than the first distance, an affirmative determination is made in step S107, and the process proceeds to step S108. In step S108, the surrounding environment is determined to be a normal (in other words, good) environment for the front camera 11, and the process flow is ended. On the other hand, when the actual recognition distance of the lane marking is shorter than the first distance, a negative determination is made in step S107, and step S110 is executed. The process corresponds to a configuration in which it is determined that the surrounding environment is the adverse environment for the front camera 11 based on the fact that the lane marking distant from the first distance or more cannot be recognized.

The content of step S107 may be a process of determining whether the actual recognition distance with respect to the landmark is equal to or longer than a predetermined first distance. The content of step S107 may be configured such that an affirmative determination is made and step S108 is executed when at least one of the actual recognition distance of the lane marking and the actual recognition distance of the landmark is equal to or longer than the first distance. By using not only the recognition distance of the lane marking but also the recognition status of the landmark as materials for determining that the environment is the normal environment for the front camera 11, it is possible to reduce the possibility of erroneously determining that the surrounding environment is the adverse environment, in a scene where it is difficult to view the lane marking due to the surrounding vehicle, for example.

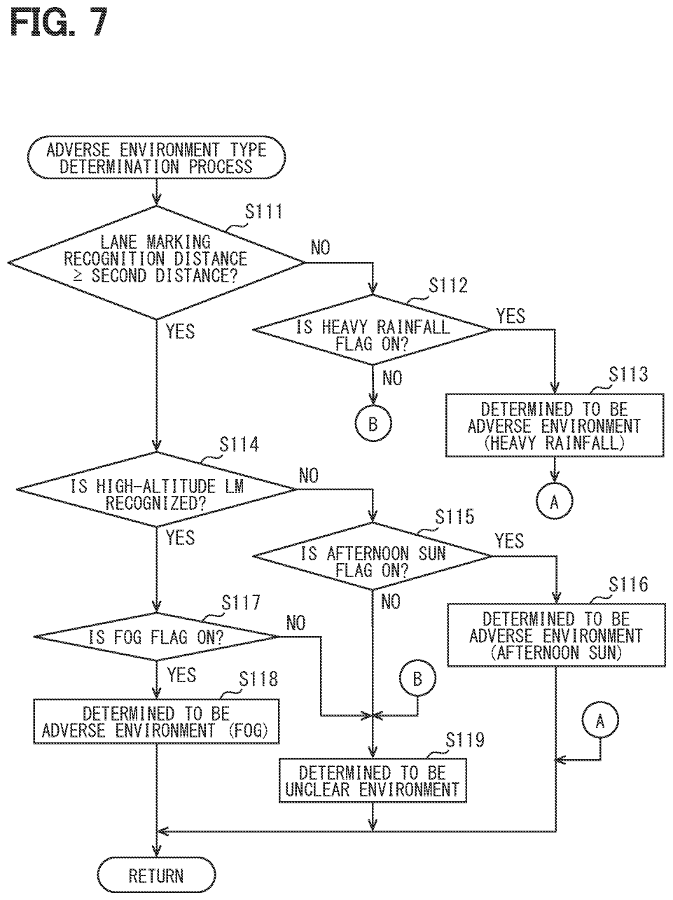

In step S110, the adverse environment type determination process is executed. The adverse environment type determination process is a process for specifying the type of the adverse environment, in other words, the cause of deterioration of the recognition capability of the front camera 11. The adverse environment type determination process will be described separately using the flowchart shown in FIG. 7. Step S110 corresponds to an environment determination step. When the adverse environment type determination process in step S110 is completed, step S190 is executed.

In step S190, the result of the adverse environment type determination process is associated with the position information and stored as adverse environment point data. The position information may include a lane ID as well as coordinates. The lane ID here indicates a lane number from the left road edge or the right road edge. A destination of the storage of the adverse environment point data may be the storage 23 or the external server. The uploading of the adverse environment point data to the external server may be realized in cooperation with the V2X in-vehicle device 16. The destination of the storage of the adverse environment point data may be an in-vehicle storage medium other than the storage 23, for example, may be the front camera 11, the driver-assistance ECU 18, the position estimator 30, or a storage medium provided in an operation recording device (not shown). The type of the adverse environment, the determination time, or the vehicle position at the time point when the determination is made, can be included in the adverse environment point data. It is preferable that the adverse environment point data includes at least one of the actual recognition distance of the lane marking and the actual recognition distance of the landmark when it is determined that the surrounding environment is the adverse environment. By including the actual recognition distance such as the lane marking, it becomes possible to specify an adverse environment level for each point and the beginning or end of the adverse environment. When the registration process in step S190 is completed, the process flow is ended.

<Regarding Adverse Environment Type Determination Process>

The type determination unit F72 executes a process shown in FIG. 7 as the adverse environment type determination process. The flowchart shown in FIG. 7 is executed as step S110 described above. As an example, the adverse environment determination process includes steps S111 to S119.

In step S111, it is determined whether the actual recognition distance of the lane marking is equal to or longer than a predetermined second distance. The second distance may be defined as, for example, 25 m or the like. The second distance is a threshold for determining whether the type of the adverse environment is heavy rainfall. It is possible to set the second distance based on the maximum value of the actual recognition distance of the lane marking that may be observed during the heavy rainfall. The second distance may be determined by a test or a simulation that reproduces a heavy rainfall situation with a predetermined amount of rainfall. The second distance may be 15 m, 20 m, 25 m, 30 m, 40 m, or the like. It is possible to set the second distance to a value equal to or shorter than the first distance. Step S111 corresponds to a process of determining whether the lane marking distant by the second distance or more from the current position can be recognized.

When the actual recognition distance of the lane marking is equal to or longer than the second distance, an affirmative determination is made in step S111, and step S114 is executed. On the other hand, when the actual recognition distance of the lane marking is shorter than the second distance, a negative determination is made in step S111, and step S112 is executed. In step S112, it is determined whether a heavy rainfall flag is ON. When the heavy rainfall flag is ON, the process proceeds to step S113, and the type of the adverse environment is determined to be heavy rainfall. Such a process corresponds to a configuration in which a determination is made that there is heavy rainfall, based on the fact that the lane marking distant by the second distance or more cannot be recognized. The environment determination unit F7 may determine that the surrounding environment is the adverse environment and that the type of the surrounding environment is heavy rainfall when both the actual recognition distance of the lane marking and the actual recognition distance of the landmark are shorter than the second distance, and the heavy rainfall flag is set to ON. Such a configuration corresponds to a configuration in which the type of the environment is determined to be heavy rainfall based on the fact that the lane marking and the landmark distant by the second distance or more from the front camera 11 are not recognized.

On the other hand, when the heavy rainfall flag is OFF, a negative determination is made in step S112, the process proceeds to step S119, and it is determined that the type of the environment is unclear. Step S119 may be a step of determining whether the surrounding environment is the adverse environment or the normal environment, or may be a step of determining that the surrounding environment is the adverse environment but the type is unclear. A series of processes from step S111 to step S113 correspond to a configuration in which a determination is made that the type of the adverse environment is heavy rainfall, based on the fact that the actual recognition distance of the lane marking is shorter than the second distance.

In step S114, it is determined whether a high-altitude landmark, which is a landmark located at a predetermined height from the road surface, can be recognized. The high-altitude landmark is, for example, a traffic sign (for example, a direction signboard) installed 4.5 m or more above the road surface. The high-altitude landmark may also be referred to as a floating landmark. The present step is a step for determining whether the type of the adverse environment is afternoon sun. When the type of the adverse environment is afternoon sun (in other words, strong backlight), it is expected that the recognizability of the high-altitude landmark is reduced. Paradoxically, when the high-altitude landmark can be recognized, it suggests that the type of the adverse environment is not the afternoon sun. When the high-altitude landmark can be recognized in step S114, an affirmative determination is made in step S114, and step S117 is executed.

On the other hand, when the high-altitude landmark cannot be recognized, a negative determination is made in step S114, and step S115 is executed. In step S115, it is determined whether an afternoon sun flag is ON. When the afternoon sun flag is ON, an affirmative determination is made in step S115, the process proceeds to step S116, and it is determined that the type of the adverse environment is afternoon sun. The above process corresponds to a configuration in which a determination is made that the type of the adverse environment is afternoon sun based on the fact that the lane marking distant by the predetermined second distance or more is recognized while the landmark of a predetermined type is not recognized, and the fact that the afternoon sun condition is satisfied. On the other hand, when the afternoon sun flag is OFF, the process proceeds to step S119, and it is determined that the type of the environment is unclear.

In step S114, before determining whether the high-altitude landmark can be recognized, a process of checking whether the high-altitude landmark is registered within a predetermined distance from the subject vehicle may be performed by referring to the map data. Step S115 or step S119 may be configured to be executed when the high-altitude landmark is not present on the map.

Step S114 may be configured such that an affirmative determination is made and the process proceeds to step S117 only when the high-altitude landmark is present within the predetermined distance from the subject vehicle on the map data and the high-altitude landmark can be recognized. The landmark used in step S114 may not be limited to the high-altitude landmark. Step S114 may be a process of determining whether the front camera 11 can recognize a landmark that is expected to be present within a predetermined third distance from the subject vehicle. The landmark that is expected to be present within the third distance from the subject vehicle refers to a landmark, which is present within the third distance of the front side of the subject vehicle, among landmarks registered in the map data. It is possible to set the third distance to be equal to or shorter than the first distance, such as 35 m or the like.

In step S114, it is determined whether the front camera 11 can recognize a backlight landmark, which is a landmark present within a predetermined angle range from the sunset direction, among the landmarks registered in the map data. The sunset direction corresponds to the predetermined direction. The environment determination unit F7 may be configured to determine that the surrounding environment is the adverse environment and that the type is afternoon sun based on the fact that the actual recognition distance of the lane marking is equal to or longer than the second distance or more and that the landmark present in the sunset direction cannot be recognized.

Also, when the afternoon sun condition is not satisfied in the first place, the possibility that the type of the adverse environment is afternoon sun is low. Step S114 and step S115 may be interchanged. Either step S114 or step S115 may be omitted. “LM” described in step S114 and the like of the flowchart refers to a landmark.

In step S117, it is determined whether the fog flag is set to ON. When the fog flag is ON, an affirmative determination is made in step S117, and the process proceeds to step S118. In step S118, the type of the adverse environment is determined to be fog, and the process flow is ended. Such an environment determination unit F7 corresponds to a configuration in which a determination is made that the type of the adverse environment is fog based on the fact that the lane marking, which is present within the second distance from the front camera 11, can be recognized and the fog occurrence condition is satisfied. On the other hand, when the fog flag is OFF, a negative determination is made in step S117, and step S119 is executed. In step S119, it is determined that the type of the environment is unclear, and the process flow is ended. The environment determination unit F7 may be configured to determine that the type of the adverse environment is fog based on the fact that both the lane marking and the landmark, which are present within the second distance from the front camera 11, can be recognized, and the fog occurrence condition is satisfied.

According to the above configuration, it is determined whether the surrounding environment is the adverse environment based on the recognition distance of the planimetric feature based on the image data captured by the front camera 11. Specifically, it is determined that the surrounding environment is the adverse environment based on the fact that the target planimetric feature, which is expected to be present within the imaging range of the front camera 11 and within a predetermined distance from the front camera 11, is not recognized. The target planimetric feature, which is expected to be present within the predetermined distance from the front camera 11, refers to, for example, the lane defining line and the landmark located in the imaging range of the front camera 11 or the designed recognizable range among the planimetric features registered on the map. That is, it corresponds to a planimetric feature that should be recognized by the front camera 11 in the normal environment.

According to the above configuration, since the determination of the type of the environment is made based on the actual recognition status with respect to the predetermined target planimetric feature by the front camera 11, it becomes possible to specify an area where the performance of the front camera 11 is substantively or actually reduced. As a comparison configuration, a configuration is conceivable in which a determination is made whether the surrounding environment is the adverse environment simply based on the air temperature, the azimuth angle, or the windshield wiper speed without using the actual recognition distance of the front camera 11. However, in the comparison configuration, there is a possibility of erroneous determination that the front camera 11 recognizes the adverse environment even though the recognition capability of the front camera 11 is not or will not be reduced. In contrast, according to the configuration of the present disclosure, since a determination of whether the surrounding environment is the adverse environment is made based on the actual recognition distance of the front camera 11, it is possible to improve the determination accuracy as compared to the configuration that determines whether the surrounding environment is the adverse environment simply based on the air temperature, the azimuth angle, and the windshield wiper speed.

According to the configuration of the present disclosure, by combining information acquired from the sensor or the device other than the front camera 11 and the recognition status of the front camera 11, it is possible to determine the type of the adverse environment. When the type of the adverse environment can be specified, it is possible for the driver-assistance ECU 18 and the like to change the system response according to the type. For example, when the type of the adverse environment is fog, a fog lamp may be turned on. When the type of the adverse environment is heavy rainfall, the vehicle speed may be reduced, or the authority may be transferred to the occupant in the driver's seat. When the type of the adverse environment is afternoon sun, the weight of the recognition result of the front camera 11 in vehicle control and/or a sensor fusion process may be decreased, or the weight (in other words, priority) of the recognition result of the millimeter wave radar 12 or the like may be increased.

According to the configuration of the present disclosure, it is possible to specify a point and a time period where the recognition capability of the front camera 11 is reduced due to any of the afternoon sun, fog, and heavy rainfall. It is possible to share the information with other vehicles.

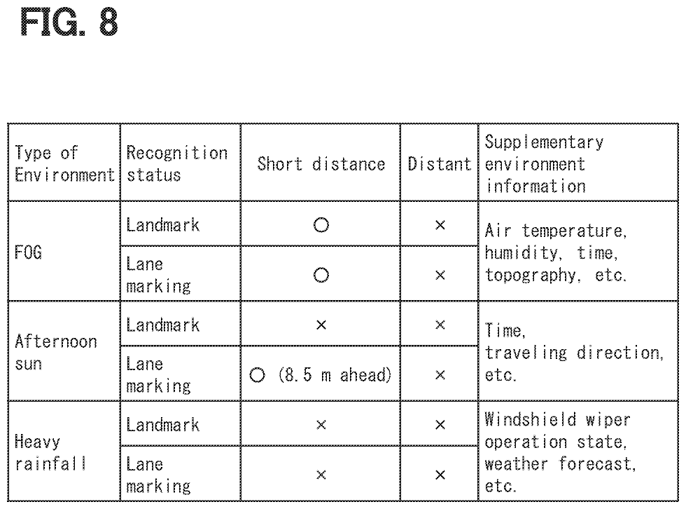

FIG. 8 shows a brief summary of the technical concept of the environment type determination method described above. In FIG. 8, distant refers to, for example, distant by the first distance or more. A short distance refers to, for example, within the second distance. As shown in FIG. 8, the present disclosure is created by paying attention to the fact that the appearance of various planimetric features may differ depending on the type of the environment, and with the configuration of the present disclosure, it is possible to specify the type of the environment from the recognition status of various planimetric features of the front camera 11.

<Supplementary of Determination Method of Type of Adverse Environment>

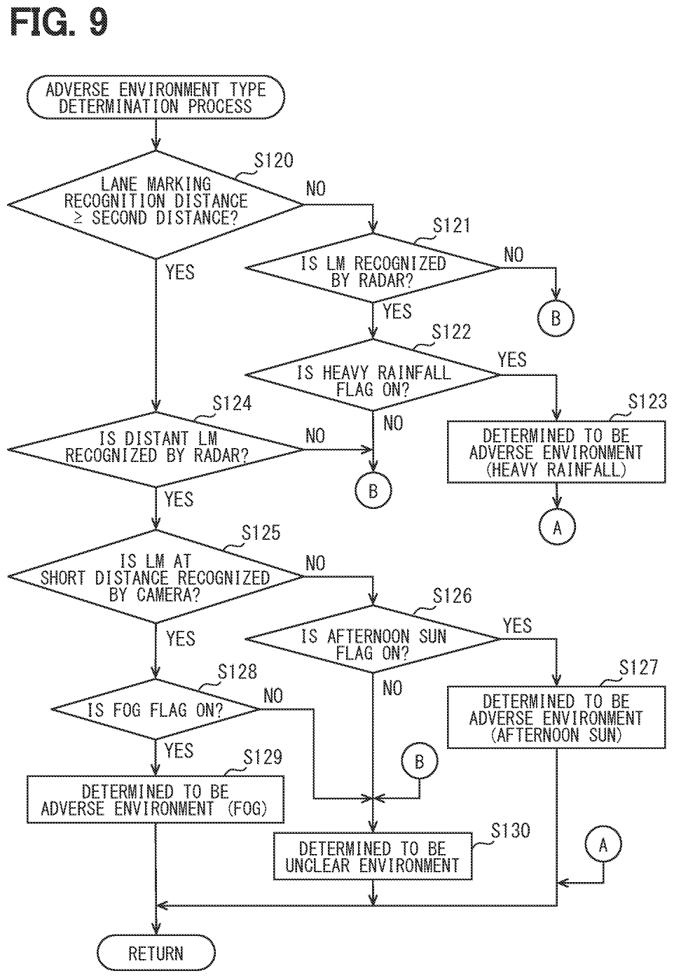

The adverse environment type determination process executed in step S110 may have the content corresponding to the flowchart shown in FIG. 9, for example. That is, the adverse environment type determination process may include steps S120 to S130. A difference between the adverse environment type determination process shown in FIG. 7 and the process shown in FIG. 9 is that the detection result of the millimeter wave radar 12 is used as a determination material of the type of the adverse environment. The adverse environment type determination process shown in FIG. 9 will be described below. The flowchart shown in FIG. 9 may also be executed as step S110.

First, in step S120, similarly to step S111, it is determined whether the actual recognition distance of the lane marking is equal to or longer than the second distance. When the actual recognition distance of the lane marking is equal to or longer than the second distance, an affirmative determination is made in step S120, and step S124 is executed. On the other hand, when the actual recognition distance of the lane marking is shorter than the second distance, a negative determination is made in step S120, and step S121 is executed. In step S121, it is determined whether the millimeter wave radar 12 recognizes a landmark that is not recognized by the front camera 11. When the millimeter wave radar 12 recognizes a landmark that is not recognized by the front camera 11, an affirmative determination is made in step S121, and the process proceeds to step S122. On the other hand, when the millimeter wave radar 12 does not recognize a landmark that is not recognized by the front camera 11, a negative determination is made in step S121, and step S130 is executed.

In step S122, it is determined whether a heavy rainfall flag is ON. When the heavy rainfall flag is ON, the process proceeds to step S123, and the type of the adverse environment is determined to be heavy rainfall. On the other hand, when the heavy rainfall flag is OFF, a negative determination is made in step S122, the process proceeds to step S130, and it is determined that the type of the environment is unclear. Step S130 may be a step of determining whether the surrounding environment is the adverse environment or the normal environment, or may be a step of determining that the surrounding environment is the adverse environment but the type is unclear. A series of processes from step S120 to step S123 correspond to a configuration in which a determination is made that the type of the adverse environment is heavy rainfall, based on the fact that the millimeter wave radar 12 can detect the landmark, and the fact that the actual recognition distance of the lane marking is shorter than the second distance.

In step S124, it is determined whether the millimeter wave radar 12 can recognize a landmark distant by a predetermined fourth distance or more. The fourth distance may be defined as, for example, 35 m or the like. The fourth distance may be 30 m, 40 m, 50 m, or the like. Steps S124 to S126 correspond, as one aspect, to a process for determining whether the type of the adverse environment is afternoon sun. The landmarks used in the determination in step S124 are preferably defined the high-altitude landmark such as a direction signboard. In step S124, it may be determined whether the millimeter wave radar 12 can recognize the backlight landmark among the landmarks registered in the map data.

When the millimeter wave radar 12 can recognize the above described landmark, an affirmative determination is made in step S124, and the process proceeds to step S125. On the other hand, when the millimeter wave radar 12 cannot recognize the above described landmark, the process proceeds to step S130. Note that “LM” described in step S124 and the like of the flowchart refers to a landmark.

In step S125, it is determined whether the front camera 11 can recognize the landmark, which is recognized within the third distance and recognized by the millimeter wave radar 12. Step S125 may be the same process as step S114. That is, the process may simply determine whether the front camera 11 can recognize the landmark within the third distance without limiting a landmark to the landmark recognized by the millimeter wave radar 12. Step S125 may be a process of determining whether the landmark, which corresponds to the high-altitude landmark or the backlight landmark among the landmarks registered in the map, can be recognized. When the afternoon sun condition is not satisfied, the possibility that the type of the adverse environment is the afternoon sun is low. Step S125 and step S126 may be interchanged. On the other hand, in step S125, when the front camera 11 can recognize the landmark that satisfies a predetermined condition, an affirmative determination is made in step S125, and the process proceeds to step S128. On the other hand, in step S125, when the front camera 11 cannot recognize the landmark that satisfies the predetermined condition, a negative determination is made in step S125, and the process proceeds to step S126.

In step S126, it is determined whether the afternoon sun flag is set to ON. When the afternoon sun flag is ON, an affirmative determination is made in step S126, the process proceeds to step S127, and it is determined that the type of the adverse environment is afternoon sun. On the other hand, when the afternoon sun flag is OFF, the process proceeds to step S130, and it is determined that the type of the environment is unclear.

In step S128, it is determined whether the fog flag is set to ON. When the fog flag is ON, an affirmative determination is made in step S128, and the process proceeds to step S129. In step S129, the type of the adverse environment is determined to be fog, and the process flow is ended. On the other hand, when the fog flag is OFF, a negative determination is made in step S128, and step S130 is executed. In step S130, it is determined that the type of the environment is unclear, and the process flow is ended.

According to the above configuration, it is determined whether the surrounding environment is the adverse environment for the front camera 11 by using the recognition status of the landmark (for example, a direction signboard) by the millimeter wave radar 12. When an object, which is detected by the millimeter wave radar 12, is not detected by the image recognition, it suggests that the surrounding environment is the adverse environment for the camera. Therefore, according to the above configuration, it is possible to further improve the determination accuracy of whether the surrounding environment is the adverse environment for the camera. By using the detection status of the millimeter wave radar 12 together to identify the type of the adverse environment, it is possible to improve the identification accuracy.

<Regarding Types of Adverse Environment>

In the above, examples of the adverse environment include heavy rainfall, fog, and afternoon sun, but the type of adverse environment is not limited to these. It is possible to include snow, sandstorm, or the like. The adverse environment such as snow, sandstorm, or the like can be determined based on the fact that a flag, which is set based on weather information, is on and that the recognition distance of the lane marking or the landmark is shorter than the first distance. It is possible to set a snow flag to ON based on whether the air temperature is equal to or lower than a predetermined value or the humidity is equal to or higher than a predetermined value. The snow flag may be set to ON based on the weather forecast. It is possible to set a sandstorm flag to ON based on the weather forecast. The sandstorm flag may be set based on the fact that the humidity is equal to or lower than a predetermined value, that the strength of the wind is equal to or greater than a predetermined value, or that the vehicle is traveling through a predetermined area where sandstorms may occur. The concept of sandstorm also includes wind dust.

<Regarding Functions of Environment Determiner 20>

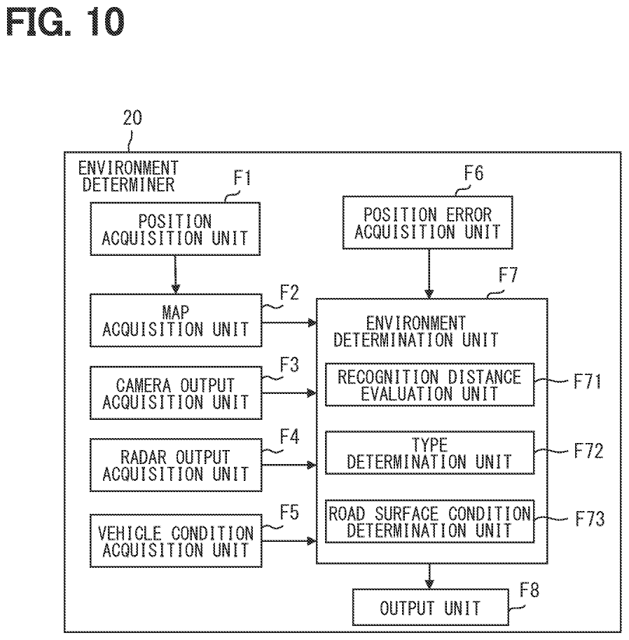

As shown in FIG. 10, the environment determiner 20 may include a road surface condition determination unit F73 that determines a road surface condition. The road surface condition includes a lane marking deterioration state, which is a state in which the lane marking becomes thin. The lane marking deterioration state includes a state in which the lane marking has completely disappeared and a state in which the lane marking is blurred and difficult to detect for the image recognition. The road surface condition also includes a condition in which many lane markings are hidden due to snow, sand, or the like. It is also possible to include a state in which the lane marking is covered with snow, sand, or the like in the adverse environment for the front camera 11.

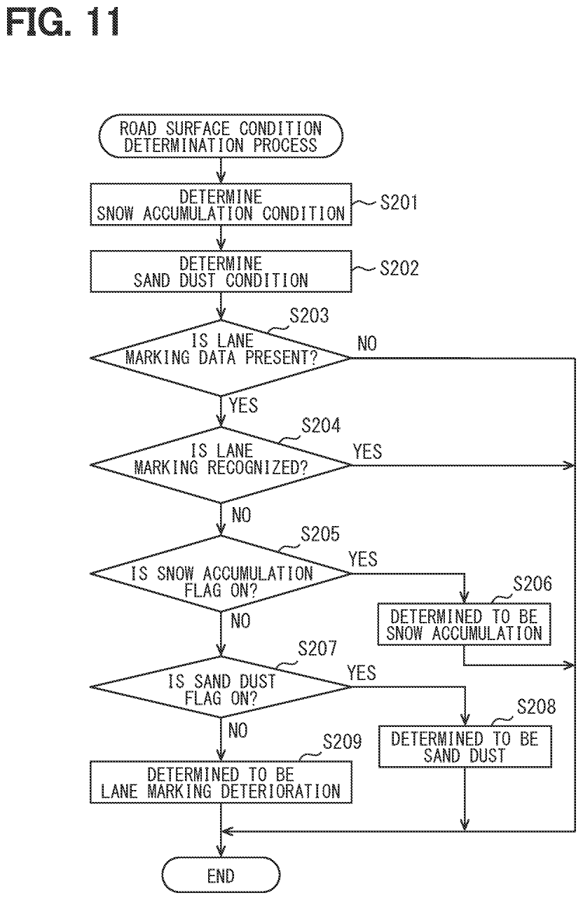

The road surface condition determination unit F73 determines whether the lane marking deteriorates, for example, by executing the flowchart shown in FIG. 11 as a road surface condition determination process. The road surface condition determination process includes steps S201 to S205, for example. The road surface condition determination process is executed at predetermined intervals, such as every 200 milliseconds.

First, in step S201, it is determined whether a snow accumulation condition is satisfied based on the weather information that can be acquired from the external server. For example, the snow accumulation condition is a condition under which it is assumed that the road is likely to be covered with snow. The snow accumulation condition is set in advance. For example, the snow accumulation condition can be defined by using at least one of the time period, the place, the air temperature, the humidity, and the weather within a certain time period in the past. For example, (a) the air temperature is equal to or lower than a predetermined value (for example, 0° C. or lower), (b) the humidity is equal to or higher than a predetermined value (for example, 80% or more), or the like can be defined as the snow accumulation condition. It may be determined that the snow accumulation condition is satisfied when a predetermined amount of snow has fallen for a certain period of time in the past. When the snow accumulation condition is satisfied, a snow accumulation flag is set to ON. On the other hand, when the snow accumulation condition is not satisfied, the snow accumulation flag is set to OFF. The snow accumulation flag is a flag indicating whether there is a possibility of snow accumulation. When step S201 is completed, the process proceeds to step S202.

When the above determination is made by the environment determiner 20, it may be configured to acquire weather history data, which indicates the history of weather within a certain period of time in the past (for example, 24 hours) in the surroundings of the current position, from the external server or the roadside device in cooperation with the V2X in-vehicle device 16. The weather history data includes a history of the air temperature, the humidity, the weather (sunny/rainy/snow), or the like. When step S201 is completed, step S202 is executed.

In step S202, it is determined whether a sand dust condition is satisfied based on the weather information that can be acquired from the external server. For example, the sand dust condition is a condition under which it is assumed that the road is likely to be covered with sand dust. The sand dust condition is set in advance. For example, the sand dust condition can be defined by using at least one of the time period, the place, the air temperature, the humidity, and the weather within a certain time period in the past. For example, (a) the humidity is lower than a predetermined value (for example, 50%), (b) the current position is in a suburb or dry area, or the like can be set as the sand dust condition. The sand dust condition may include the fact that it has not rained or snowed within a certain period of time in the past. Alternatively, it may be determined that the sand dust condition is satisfied when sandstorm has occurred within a certain period of time in the past. When the sand dust condition is satisfied, a sand dust flag is set to ON. On the other hand, when the sand dust condition is not satisfied, the sand dust flag is set to OFF. The sand dust flag is a flag indicating whether there is a possibility of sand dust accumulation on the road. When step S202 is completed, the process proceeds to step S203.

In step S203, based on the map data acquired by the map acquisition unit F2, it is determined whether the lane marking is present on the road on which the subject vehicle is traveling. When the subject vehicle is traveling on a road whose lane marking information is registered on the map, an affirmative determination is made in step S203, and step S204 is executed. On the other hand, when the subject vehicle is traveling on a road whose lane marking information is not registered on the map, a negative determination is made in step S203, and the process flow is ended. When a negative determination is made in step S203, the road surface condition may be determined to be unclear or normal, and the process flow may be ended.

In step S204, it is determined whether the lane markings on both the left and right sides of the subject vehicle traveling lane can be recognized. For example, it is determined whether the lane markings on both sides are recognized at a predetermined distance (for example, 8.5 m) from the subject vehicle. When at least one of the left and right lane markings cannot be recognized, a negative determination is made in step S204, and step S205 is executed. On the other hand, when the lane markings on both sides can be recognized, the road surface condition is determined to be normal, and the process flow is ended.

In step S205, it is determined whether the snow accumulation flag is set to ON. When the snow accumulation flag is set to ON, the process proceeds to step S206. On the other hand, when the snow accumulation flag is OFF, the process proceeds to step S207. In step S206, it is determined that lane marking is difficult to recognize due to the snow accumulation, and the process flow is ended.

In step S207, it is determined whether the sand dust flag is set to ON. When the sand dust flag is set to ON, the process proceeds to step S208. On the other hand, when the sand dust flag is OFF, the process proceeds to step S209. In step S208, it is determined that it is difficult to recognize lane marking due to sand dust covering the road, and the process flow is ended. In step S209, it is determined that it is in the lane marking deterioration state, and the process flow is ended.

According to the above configuration, the state of the lane marking is determined based on the actual recognition status of the lane marking (for example, the actual recognition distance) of the front camera 11, thereby it is possible to determine the state of the lane marking with high accuracy. It becomes also possible to collect information on a point where the lane marking deteriorates. According to the present disclosure, the road surface condition such as snow accumulation is determined based on not only the weather information but also the actual recognition status of lane marking by the front camera 11. Therefore, it is possible to improve the determination accuracy as compared with the configuration in which the road surface condition is determined based only on the weather information. In the road surface condition determination process, a part or all of steps S201, S202, or steps S205 to S208 are any elements and can be omitted.

It is preferable that the determination result of various road surface conditions is determined when the same determination result is obtained consecutively at a certain period of time (for example, 3 seconds) or a certain number of times (for example, 3 times or more). According to the configuration, it is possible to reduce the possibility of erroneously determining the road surface condition due to momentary noise or the like.

The road surface condition determination unit F73 may determine that it is in the lane marking deterioration state when the front camera 11 can recognize the landmark but cannot recognize the lane marking in a section, where the lane marking is registered on the map, and when the snow accumulation flag or the sand dust flag is OFF. According to the configuration in which the fact that the landmark can be recognized is added to the deterioration condition of the lane marking deterioration state, it is possible to exclude the possibility of the adverse environment such as heavy rainfall and the possibility that the front camera 11 is out of order.

<Supplementary Materials for Adverse Environment>

The environment determination unit F7 may acquire the reliability of the recognition result from the front camera 11 and determine that the surrounding environment is the adverse environment based on the fact that the reliability is equal to or less than a predetermined threshold. For example, the surrounding environment may be determined to be the adverse environment when a state in which the reliability is equal to or less than a predetermined threshold continues for a predetermined period of time, or when a travel distance in the state in which the reliability is equal to or less than a predetermined threshold, is equal to or longer than a predetermined value.

The environment determination unit F7 evaluates the recognition performance based on a miss rate, which is a rate of failure to detect the landmark that is registered on the map and that should be detected on the traveling locus of the subject vehicle. The miss rate can be calculated based on the total number N of the landmarks registered on the map within a certain distance and the number of successful detections m, which is the number of landmarks that can be detected before passing through. For example, the miss rate may be calculated by (N−m)/N. In this case, it shows that the smaller the miss rate, the more likely the front camera 11 can normally recognize various landmarks. As another aspect, the total number N may be the number of landmarks, which are present within a predetermined distance (for example, 35 m) in front of the current position and which should be visible from the current position. In that case, the number m of successful detections may be the number of landmarks that can be detected at the current position. The environment determination unit F7 may determine that the surrounding environment is the adverse environment based on the fact that the miss rate is equal to or greater than a predetermined value.

In the above, a configuration has been disclosed in which it is determined whether the surrounding environment is the adverse environment by combining the actual recognition distance of the lane markings or the environmental conditions in a complex manner, but the present disclosure is not limited thereto. For example, the environment determination unit F7 may determine whether the surrounding environment corresponds to the adverse environment based on the actual recognition distance with respect to the landmark calculated by the recognition distance evaluation unit F71. More specifically, the environment determination unit F7 may determine that the surrounding environment is the adverse environment when the actual recognition distance of the landmark is smaller than a predetermined fifth distance. The fifth distance for determining the adverse environment with respect to the actual recognition distance of landmark may be the same as or different from the first distance, which is a threshold for determining the adverse environment with respect to the actual recognition distance of the lane marking. The fifth distance can be 20 m, 25 m, 30 m, or the like.

The environment determination unit F7 as the type determination unit F72 may determine heavy rainfall, for example, when the landmark distant by the second distance or more cannot be recognized and the driving speed of the windshield wiper is equal to or greater than a predetermined threshold. Rainfall may be classified into multiple stages according to the strength of rainfall (that is, amount of rainfall), such as light rainfall, strong rainfall, heavy rainfall, or the like, instead of being classified only into heavy rainfall. When the operation speed of the windshield wiper is low, it may be determined that it is light rainfall. In the present disclosure, as an example, rainfall with an amount of rainfall of less than 20 mm is described as light rainfall, and rainfall with an amount of rainfall of equal to or greater than 20 mm and less than 50 mm is described as strong rainfall. The strength of rain is classified into three stages, but the number of classifications of the strength of rain can be changed as appropriate.

A distance threshold, which is a threshold with respect to the actual recognition distance, such as the first distance to the fifth distance, may be determined according to the designed recognition limit distance. For example, the first distance and the fifth distance may be set to values corresponding to 20% to 40% of the designed recognition limit distance. The second distance or the like may be set to a value corresponding to 10% to 20% of the designed recognition limit distance. The distance threshold such as the first distance may be adjusted according to the type of the traveling road. The distance threshold used for intercity highways may be a larger value than the distance threshold used for general roads or local highways. Since the traveling speed is higher on intercity highways than on general roads, it is preferable to set a strict threshold for determining that the surrounding environment is relatively in the adverse environment.

The determination of the adverse environment based on the actual recognition distance of the landmark or the lane marking may be canceled when a preceding vehicle is present or on a curved road. The curved road here refers to a road whose curvature is equal to or greater than a predetermined threshold. According to the above configuration, it is possible to reduce the possibility of erroneously determining that the surrounding environment is the adverse environment due to the presence of a preceding vehicle or a change in curvature. When a preceding vehicle is present, it is sufficient to follow the preceding vehicle and travel, so there is no need to measure the position of the subject vehicle so strictly. Accordingly, the need to determine whether the surrounding environment is the adverse environment is not high. In other words, a scene, in which no preceding vehicle is present, is a scene in which it is highly necessary to accurately estimate the position of the subject vehicle. The driver-assistance ECU 18 may be configured to change the content of the process to be executed, in other words, the system response, depending on whether no preceding vehicle is present and the surrounding environment is determined to be the adverse environment.

The environment determination unit F7 may determine whether the surrounding environment is the adverse environment based on the recognition status of the road edge, instead of or in parallel with the lane marking. For example, it may be determined to be the adverse environment based on the fact that the road edge distant by the first distance or more cannot be recognized. When the front camera 11 is configured to be able to perform image recognition on the character string included in the guide sign, it may be determined that the surrounding environment is the adverse environment based on the fact that the character string in the guide sign cannot be recognized. When the front camera 11 is configured to be able to perform the image recognition on the character string included in the guide sign, it may be determined that the surrounding environment is the adverse environment based on the fact that the effective distance within which the character string can be recognized, is shorter than a predetermined value.

The environment determination unit F7 may determine whether the surroundings of the subject vehicle correspond to the adverse environment by acquiring data of the area corresponding to the adverse environment, from the map server. For example, the map server is a server that specifies and distributes adverse environment areas based on reports from multiple vehicles. According to such a configuration, it is possible to reduce the computational load for determining whether the surrounding environment is the adverse environment. The environment determination unit F7 may share the provisional determination result of whether the surrounding environment is the adverse environment with other vehicles via the V2X in-vehicle device 16 and may determine whether the surrounding environment corresponds to the adverse environment by majority vote or the like.

Generally, during heavy rainfall, the millimeter wave radar 12 tends to increase unnecessary reflected electric power due to raindrops. Therefore, it may be determined that the type of the adverse environment is heavy rainfall based on the fact that the unnecessary reflected electric power observed by the millimeter wave radar 12 is equal to or greater than a predetermined threshold. The millimeter wave radar 12 generally has a feature that the detection performance of a vehicle or the like is less likely to be reduced even during the heavy rainfall, but this is not the case for objects such as bicycles whose reflection intensity is weak. The detectable distance may decrease during heavy rainfall for objects with weak reflection intensity, such as bicycles. The same applies to a small object such as a tire that has detached from the vehicle. Therefore, it may be determined that the surrounding environment is heavy rainfall based on the fact that the detectable distance of a bicycle or a small object by the millimeter wave radar 12 is decreased.

<Regarding Determination of Adverse Environment Level>

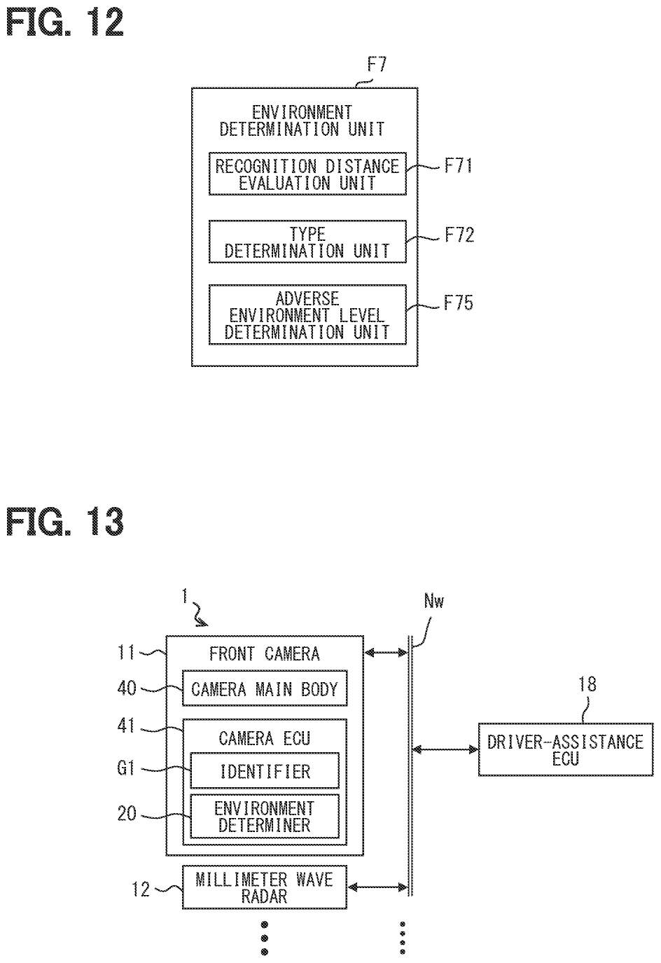

As shown in FIG. 12, the environment determination unit F7 may include an adverse environment level determination unit F75 that evaluates a level of the adverse environment, in other words, a level of deterioration in object recognition performance using the image frame. The adverse environment level can be represented in four stages, 0 to 3, for example. A higher level indicates a higher adverse environment level. The adverse environment level can be evaluated based on the actual recognition distance of the landmark or the lane marking. For example, the adverse environment level determination unit F75 determines that the shorter the actual recognition distance of the lane marking, the higher the adverse environment level. For example, Level 1 is determined when the recognition distance of the lane marking is equal to or longer than 35 m and shorter than 50 m, and Level 2 is determined when the recognition distance of the lane marking is equal to or longer than 20 m and shorter than 35 m. Level 3 is determined when the recognition distance of the lane marking is shorter than 20 m, and Level 0 may be determined when the recognition distance of the lane marking is equal to or longer than a predetermined value (for example, 50 m). Level 0 refers that the surrounding environment is not the adverse environment. The level number indicating the adverse environment level can be changed as appropriate. The adverse environment level determination unit F75 may determine the adverse environment level by using a miss rate instead of or in combination with the actual recognition distance of a predetermined planimetric feature.

The adverse environment level determination unit F75 may evaluate the adverse environment level according to the amount of rainfall. For example, when the amount of rainfall corresponds to light rainfall, the adverse environment level is set to Level 1, and when the amount of rainfall corresponds to strong rainfall, the adverse environment level is set to Level 2. When the amount of rainfall corresponds to heavy rainfall, the adverse environment level is set to Level 3. The amount of rainfall may be estimated from the driving speed of the windshield wiper blade or may be determined by acquiring the weather information from the external server.

<Regarding Disposition of Environment Determiner 20>

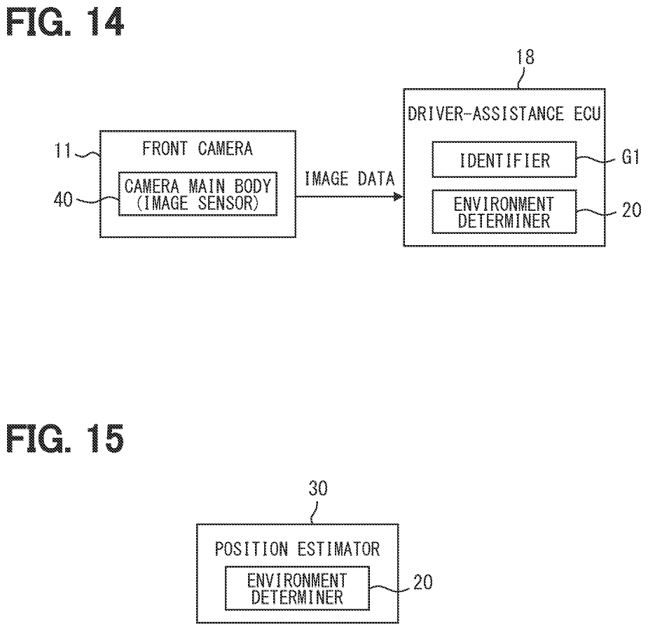

Although the configuration in which the environment determiner 20 is disposed outside the front camera 11 is exemplified in the above-described embodiment, the disposition of the environment determiner 20 is not limited thereto. As shown in FIG. 13, the function of the environment determiner 20 may be included in the camera ECU 41. As shown in FIG. 14, the function of the environment determiner 20 may be included in the driver-assistance ECU 18. The environment determiner 20 may be integrated with the position estimator 30 as shown in FIG. 15. The position estimator 30 including the function of the environment determiner 20 may also be built in the camera ECU 41 or the driver-assistance ECU 18. The functional disposition of each configuration can be changed as appropriate. The functions of the camera ECU 41 such as the identifier 411 may also be included in the driver-assistance ECU 18. That is, the front camera 11 may be configured to output the image data to the driver-assistance ECU 18, and the driver-assistance ECU 18 may be configured to execute a process such as the image recognition.

<Regarding Cooperation with Map Server 5>

The environment determiner 20 may be configured to cooperate with the V2X in-vehicle device 16 and upload a communication packet, which indicates information on a point determined to be in the adverse environment, to the map server 5 as the adverse environment reports. The map server 5 may be configured to specify a point where the sensing capability of the front camera 11 may deteriorate (that is, an adverse environment point) by statistically processing the adverse environment reports uploaded from each vehicle, for example. The adverse environment point can be defined as a section or a road segment having a certain length. The expression “point” includes a concept of a section or an area having a predetermined length. The expression “adverse environment point” can also be read as “adverse environment area”.

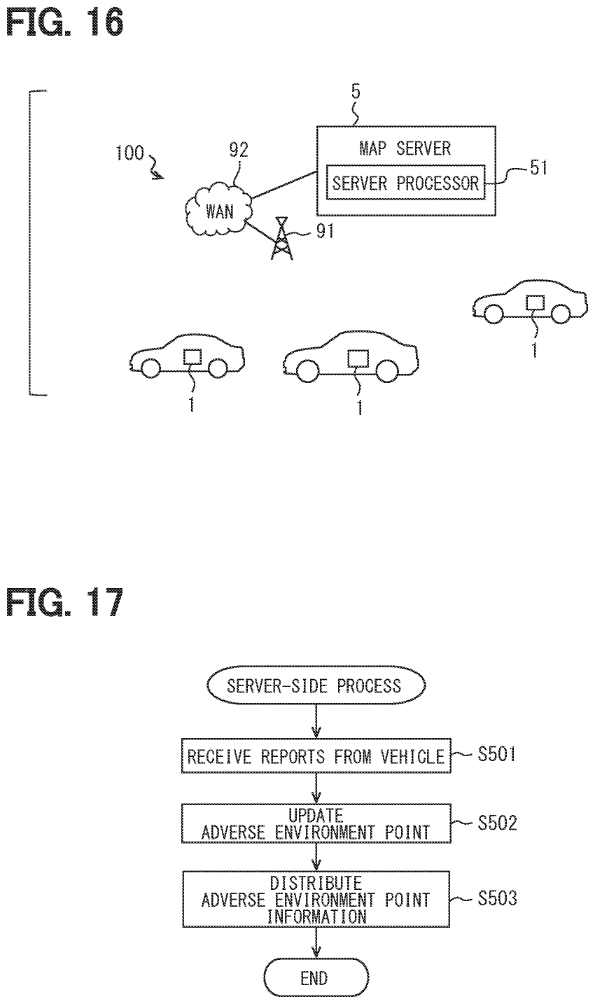

FIG. 16 shows a map distribution system 100 including a map server 5 that specifies an adverse environment point based on reports of the adverse environment points from multiple vehicles. 91 shown in FIG. 16 represents a wide area communication network, and 92 represents a wireless base station. The wide area communication network 91 refers to a public communication network provided by a telecommunication carrier, such as a cellular phone network and the Internet.

FIG. 17 schematically shows a flow of a process executed by the map server 5. The process of the map server 5 includes step S501 of receiving the adverse environment reports from the multiple vehicles, step S502 of setting and canceling the adverse environment point based on the received reports, and step S503 of distributing the adverse environment point information. The following various processes including the flowchart in FIG. 17 are executed by a server processor 51 provided in the map server 5.

For example, the map server 5 sets a point, where the number of adverse environment reports from the vehicles within a predetermined time is equal to or greater than a predetermined threshold, as the adverse environment point (step S502). The adverse environment point may be, for example, a point where an adverse environment factor such as fog or heavy rainfall actually occurs, or may be a point where the actual recognition distance begins to decrease due to the influence of the adverse environment factor. A statistical process here includes majority voting or averaging. The adverse environment point may be registered in units of lanes or registered in units of links.

The map server 5 distributes data, which indicates the specified adverse environment point, to the vehicle. The map server 5 can distribute the adverse environment point data for a requested area, for example, based on a request from the vehicle. When the map server 5 is configured to be able to acquire the current position of each vehicle, the adverse environment point data may be automatically distributed to vehicles scheduled to enter the adverse environment point. That is, the adverse environment point data may be distributed by either pull distribution or push distribution.

The adverse environment factor is a dynamic element whose presence changes in a relatively short period of time compared to road structures and the like. Therefore, it is preferable that the map server 5 sets or cancels the adverse environment point based on the adverse environment reports acquired within a predetermined valid time shorter than 90 minutes. The valid time is set to 10 minutes, 20 minutes, 30 minutes, or the like, for example. According to the configuration, it is possible to ensure the real-time nature of the distribution data for the adverse environment point. The data about a certain adverse environment point is updated periodically, for example, based on reports from vehicles passing through the point. For example, regarding a point that is set as the adverse environment point, when the number of vehicles, which reports that the point is in the adverse environment, is less than a predetermined threshold, it is determined that the point is no longer in the adverse environment.

It is preferable that the distribution data about the adverse environment point includes the start and end position coordinates of the section regarded as the adverse environment, the type of the adverse environment, a level of the adverse environment, the final determination time, and the time when the determination is made to be the adverse environment. The map server 5 may calculate the reliability of the determination result that the surrounding environment is the adverse environment, add the reliability in the data about the adverse environment point, and distribute the data to the vehicle. The reliability indicates a level of possibility that the surrounding environment is actually the adverse environment. The reliability may be set to a larger value, for example, as the number or ratio of vehicles reporting that the surrounding environment is the adverse environment is higher. The map server 5 may acquire information for specifying the adverse environment point from a roadside device or the like in addition to the reports from the vehicles. For example, when the roadside device is provided with a camera, image data that is captured by the camera can be used as a material for determining whether the surrounding environment is the adverse environment.

<Usage Embodiment of Adverse Environment Point Information>

The adverse environment point information generated by the map server 5 may be used, for example, to determine whether autonomous driving can be executed. As a road condition for autonomous driving, there may be a configuration in which the actual recognition distance of the front camera 11 is defined to be equal to or longer than a predetermined value (for example, 40 m). In such a configuration, a section in which the actual recognition distance of the front camera 11 may be shorter than a predetermined value due to fog, heavy rainfall, or the like may be an autonomous driving prohibited section.

The vehicle side (for example, the driver-assistance ECU 18) may be configured to determine whether the section corresponds to the autonomous driving prohibited section. Further, the map server 5 may set an autonomous driving prohibited section based on the obstacle information and distribute the autonomous driving prohibited section. For example, in the map server 5, the section where the actual recognition distance of the front camera 11 decreases is set as the autonomous driving prohibited section and delivered, and when the disappearance or mitigation of the adverse environment factor is recognized, the autonomous driving prohibited setting is canceled and delivered. The server, which distributes the setting of the autonomous driving prohibited section and the like, may be provided separately from the map server 5 as an autonomous driving management server. The autonomous driving management server corresponds to a server for managing an autonomous driving available or unavailable section. As described above, the information about the adverse environment point can be used to determine whether an Operational Design Domain (ODD) set for each vehicle is satisfied.

<Appendix (1)>

The control unit and the method thereof described in the present disclosure may be implemented by a dedicated computer constituting a processor programmed to execute one or multiple functions embodied by a computer program. The device and the method thereof described in the present disclosure may be implemented by a dedicated hardware logic circuit. Further, the device and the method thereof described in the present disclosure may be implemented by one or more dedicated computers configured by a combination of a processor that executes a computer program and one or more hardware logic circuits. The computer program may be stored in a computer-readable non-transitional tangible recording medium as an instruction executed by a computer. The means and/or functions provided by the processing units 21 and 31 may be provided by software stored in a tangible memory device and a computer executing the software, only software, only hardware, or a combination of the software and the hardware. A part or all of the functions of the environment determiner 20 may be realized as hardware. An aspect in which a certain function is realized as hardware includes an aspect in which the function is realized by using one or multiple ICs. For example, the processing unit 21 may be realized by using an MPU or GPU instead of the CPU. The processing unit 21 may be realized by combining multiple types of calculation processing devices such as a CPU, an MPU, and a GPU. Furthermore, the ECU may be realized by using a Field-Programmable Gate Array (FPGA) or an Application Specific Integrated Circuit (ASIC). The same applies to the processing unit 31. Various programs may be stored in a non-transitory tangible storage medium. Various storage media, such as a Hard-Disk Drive (HDD), a Solid State Drive (SSD), an Erasable Programmable ROM (EPROM), and a flash memory, can be adopted as a storage medium of the program.

<Appendix (2)>

The present disclosure also includes the following configurations.

[Configuration (1)]

A vehicle camera unit, which is an imaging device (11) that images a predetermined range of surroundings of a vehicle, the vehicle camera unit includes:

an object recognition unit (411) that recognizes a position of a predetermined target planimetric feature by analyzing a captured image;

a supplementary information acquisition unit (F2, F4, F5) that acquires, as supplementary environment information, information indicating an outside environment of the vehicle from a sensor other than the imaging device;

an environment determination unit (F7) that determines whether a surrounding environment of the vehicle is an adverse environment for a device that recognizes an object by using an image, based on at least one of a recognition result of the target planimetric feature acquired by an image recognition information acquisition unit and supplementary environment information acquired by the supplementary information acquisition unit; and

an output unit (F8) that outputs a determination result of the environment determination unit.

According to the configuration in which the environment determination unit is integrated with the camera unit as described above, the cost can be reduced compared to the configuration in which the environment determination unit is provided outside the camera.

[Configuration (2)]

A map server is configured to acquire, from each of multiple vehicles, report data indicating a determination result of whether a surrounding environment of the vehicle is an adverse environment for an on-board camera, in association with position information,

to detect a point that is in the adverse environment for the on-board camera by performing a statistical process on information that is acquired from the multiple vehicles, and

to successively determine whether the point, which is considered to be in the adverse environment, is still in the adverse environment, based on report data acquired from the multiple vehicles.

According to the above configuration, determination accuracy can be improved because the determination results of the multiple vehicles are integrated to specify the adverse environmental point as compared to the configuration in which the adverse environment point is specified with the vehicle alone. Further, since it is possible to distribute highly accurate adverse environment point information to the multiple vehicles, the safety of traffic society can be improved.

[Configuration (3)]

A driver-assistance device that assists a driving operation of an occupant in the driver's seat, the driver-assistance device includes:

an image recognition information acquisition unit (F3) that acquires, as image recognition information, information indicating recognition information about a predetermined target planimetric feature that is defined by analyzing an image captured by an imaging device (11) that images a predetermined range of surroundings of a vehicle; and

an environment determination unit (F7) that determines whether a surrounding environment of the vehicle is an adverse environment for a device that recognizes an object by using the image, based on a recognition result of the target planimetric feature acquired by the image recognition information acquisition unit,

in which the driver-assistance device changes the content of a driver-assistance (in other words, a system response) based on a determination result of the environment determination unit.

According to the above configuration, the driver-assistance is executable according to the surrounding environment. For example, the driver-assistance based on the fact that the surrounding environment is the adverse environment, is executable.

1. An adverse environment determination device, comprising:
an image recognition information acquisition unit that is configured to acquire, as image recognition information, information indicative of a recognition result of a target planimetric feature, the recognition result being determined by analyzing an image captured by an imaging device that is configured to capture the image of a predetermined range of surroundings of a vehicle;
an environment determination unit that is configured to determine, based on the recognition result of the target planimetric feature acquired by the image recognition information acquisition unit, whether a surrounding environment of the vehicle is an adverse environment for a device that is configured to perform object recognition using the image captured by the imaging device; and
a recognition distance evaluation unit that is configured to determine, based on the image recognition information, an actual recognition distance that is an actual distance within which the target planimetric feature is actually recognized, wherein
the target planiemetric feature includes a lane defining line,
the recognition distance evaluation unit is configured to calculate the actual recognition distance for the lane defining line,
the environment determination unit is configured to:
determine that the surrounding environment is the adverse environment when the actual recognition distance for the lane defining line is shorter than a predetermined threshold; and
determine a type of the adverse environment based on the actual recognition distance for the lane defining line upon determining that the surrounding environment is the adverse environment.

2. An adverse environment determination device, comprising:
an image recognition information acquisition unit that is configured to acquire, as image recognition information, information indicative of a recognition result of a target planimetric feature, the recognition result being determined by analyzing an image captured by an imaging device that is configured to capture the image of a predetermined range of surroundings of a vehicle;
an environment determination unit that is configured to determine, based on the recognition result of the target planimetric feature acquired by the image recognition information acquisition unit, whether a surrounding environment of the vehicle is an adverse environment for a device that is configured to perform object recognition using the captured image; and
a recognition distance evaluation unit that is configured to determine, based on the image recognition information, an actual recognition distance that is an actual distance within which the target planimetric feature is actually recognized, wherein
the target planiemetric feature includes a landmark,
the recognition distance evaluation unit is configured to calculate the actual recognition distance for the landmark,
the environment determination unit is configured to:
determine that the surrounding environment is the adverse environment when the actual recognition distance for the landmark is shorter than a predetermined threshold; and
determine a type of the adverse environment based on the actual recognition distance for the landmark upon determining that the surrounding environment is the adverse environment.

3. The adverse environment determination device according to claim 1, wherein
the target planimetric feature includes the lane defining line and a landmark, and
the environment determination unit is configured to specify a type of the surrounding environment based on a recognition status of the lane defining line and a recognition status of the landmark.

4. An adverse environment determination device, comprising:
an image recognition information acquisition unit that is configured to acquire, as image recognition information, information indicative of a recognition result of a target planimetric feature, the recognition result being determined by analyzing an image captured by an imaging device that is configured to capture the image of a predetermined range of surroundings of a vehicle;
an environment determination unit that is configured to determine, based on the recognition result of the target planimetric feature acquired by the image recognition information acquisition unit, whether a surrounding environment of the vehicle is an adverse environment for a device that is configured to perform object recognition using the captured image; and
a recognition distance evaluation unit that is configured to determine, based on the image recognition information, an actual recognition distance that is an actual distance within which the target planimetric feature is actually recognized, wherein
the target planiemetric feature includes both a lane defining line and a landmark,
the recognition distance evaluation unit is configured to calculate the actual recognition distance for the lane defining line and the actual recognition distance for the landmark,
the environment determination unit is configured to:
determine that the surrounding environment is the adverse environment when at least one of the actual recognition distance for the lane defining line and the actual recognition distance for the landmark is shorter than a predetermined threshold; and
determine a type of the adverse environment based on the actual recognition distance for the lane defining line and the actual recognition distance for the landmark upon determining that the surrounding environment is the adverse environment.

5. The adverse environment determination device according to claim 1, further comprising:
a supplementary information acquisition unit that is configured to acquire, as supplementary environment information, information indicative of an outside environment of the vehicle from a sensor other than the imaging device, wherein
the environment determination unit is configured to:
determine whether the surrounding environment of the vehicle is the adverse environment based on the recognition result of the target planimetric feature acquired by the image recognition information acquisition unit and the supplementary environment information acquired by the supplementary information acquisition unit; and
determine a type of the adverse environment upon determining that the surrounding environment is the adverse environment.

6. The adverse environment determination device according to claim 5, wherein
the target planimetric feature includes the lane defining line and a landmark,
the supplementary information acquisition unit is configured to acquire at least one of a traveling direction of the vehicle, time information, and an altitude of the sun, and
the environment determination unit is configured to:
determine whether a predetermined afternoon sun condition is satisfied based on the information acquired by the supplementary information acquisition unit; and
determine that the surrounding environment is an afternoon sun situation as the adverse environment when the afternoon sun condition is satisfied and the lane defining line away from the vehicle by a predetermined distance or more is recognized but a predetermined type of the landmark or the landmark present in a predetermined direction is not recognized.

7. An adverse environment determination device, comprising:
an image recognition information acquisition unit that is configured to acquire, as image recognition information, information indicative of a recognition result of a target planimetric feature, the recognition result being determined by analyzing an image captured by an imaging device that is configured to capture the image of a predetermined range of surroundings of a vehicle;
an environment determination unit that is configured to determine, based on the recognition result of the target planimetric feature acquired by the image recognition information acquisition unit, whether a surrounding environment of the vehicle is an adverse environment for a device that is configured to perform object recognition using the captured image; and
a supplementary information acquisition unit that is configured to acquire, as supplementary environment information, information indicative of an outside environment of the vehicle from a sensor other than the imaging device, wherein
the target planimetric feature includes both a lane defining line and a landmark,
the supplementary information acquisition unit is configured to acquire at least one of a traveling direction of the vehicle, time information, and an altitude of the sun,
the environment determination unit is configured to:
determine whether the surrounding environment of the vehicle is the adverse environment based on the recognition result of the target planimetric feature acquired by the image recognition information acquisition unit and the supplementary environment information acquired by the supplementary information acquisition unit; and
determine a type of the adverse environment upon determining that the surrounding environment is the adverse environment,
the environment determination unit is further configured to:
determine whether a predetermined afternoon sun condition is satisfied based on the information acquired by the supplementary information acquisition unit; and
determine that the surrounding environment is an afternoon sun situation as the adverse environment when the afternoon sun condition is satisfied and the lane defining line away from the vehicle by a predetermined distance or more is recognized but a predetermined type of the landmark or the landmark present in a predetermined direction is not recognized.

8. The adverse environment determination device according to claim 5, wherein
the target planimetric feature includes the lane defining line and a landmark,
the supplementary information acquisition unit is configured to acquire at least one of an outside air temperature, a humidity, time, and a current position, and
the environment determination unit is configured to:
determine whether a predetermined fog condition is satisfied based on the information acquired by the supplementary information acquisition unit; and
determine that the type of the adverse environment is fog when the fog occurrence condition is satisfied and the lane defining line and the landmark that are located within a predetermined distance from the imaging device are recognized.

9. An adverse environment determination device, comprising:
an image recognition information acquisition unit that is configured to acquire, as image recognition information, information indicative of a recognition result of a target planimetric feature, the recognition result being determined by analyzing an image captured by an imaging device that is configured to capture the image of a predetermined range of surroundings of a vehicle;
an environment determination unit that is configured to determine, based on the recognition result of the target planimetric feature acquired by the image recognition information acquisition unit, whether a surrounding environment of the vehicle is an adverse environment for a device that is configured to perform object recognition using the captured image; and
a supplementary information acquisition unit that is configured to acquire, as supplementary environment information, information indicative of an outside environment of the vehicle from a sensor other than the imaging device, wherein
the target planimetric feature includes both a lane defining line and a landmark,
the supplementary information acquisition unit is configured to acquire at least one of an outside air temperature, a humidity, time, and a current position, and
the environment determination unit is configured to:
determine whether the surrounding environment of the vehicle is the adverse environment based on the recognition result of the target planimetric feature acquired by the image recognition information acquisition unit and the supplementary environment information acquired by the supplementary information acquisition unit; and
determine a type of the adverse environment upon determining that the surrounding environment is the adverse environment, and
the environment determination unit is further configured to:
determine whether a predetermined fog condition is satisfied based on the information acquired by the supplementary information acquisition unit; and
determine that the type of the adverse environment is fog when the fog occurrence condition is satisfied and the lane defining line and the landmark that are located within a predetermined distance from the imaging device are recognized.

10. The adverse environment determination device according to claim 5, wherein
the target planimetric feature includes the lane defining line and a landmark,
the supplementary information acquisition unit is configured to acquire at least one of a humidity, an operation speed of a windshield wiper, and weather information, and
the environment determination unit is configured to:
determine whether a predetermined heavy rainfall condition is satisfied based on the information acquired by the supplementary information acquisition unit; and
determine that the type of the adverse environment is heavy rainfall when the heavy rainfall condition is satisfied and both the lane defining line and the landmark that are away from the imaging device by a predetermined distance or more are not recognized.

11. An adverse environment determination device, comprising:
an image recognition information acquisition unit that is configured to acquire, as image recognition information, information indicative of a recognition result of a target planimetric feature, the recognition result being determined by analyzing an image captured by an imaging device that is configured to capture the image of a predetermined range of surroundings of a vehicle;
an environment determination unit that is configured to determine, based on the recognition result of the target planimetric feature acquired by the image recognition information acquisition unit, whether a surrounding environment of the vehicle is an adverse environment for a device that is configured to perform object recognition using the captured image; and
a supplementary information acquisition unit that is configured to acquire, as supplementary environment information, information indicative of an outside environment of the vehicle from a sensor other than the imaging device, wherein
the target planimetric feature includes both a lane defining line and a landmark,
the supplementary information acquisition unit is configured to acquire at least one of a humidity, an operation speed of a windshield wiper, and weather information,
the environment determination unit is configured to:
determine whether the surrounding environment of the vehicle is the adverse environment based on the recognition result of the target planimetric feature acquired by the image recognition information acquisition unit and the supplementary environment information acquired by the supplementary information acquisition unit; and
determine a type of the adverse environment upon determining that the surrounding environment is the adverse environment, and
the environment determination unit is further configured to:
determine whether a predetermined heavy rainfall condition is satisfied based on the information acquired by the supplementary information acquisition unit; and
determine that the type of the adverse environment is heavy rainfall when the heavy rainfall condition is satisfied and both the lane defining line and the landmark that are away from the imaging device by a predetermined distance or more are not recognized.

12. The adverse environment determination device according to claim 6, wherein
the supplementary information acquisition unit is a distance measuring sensor information acquisition unit that is configured to acquire, as distance measuring sensor information, information indicative of a recognition result of a distance measuring sensor that is configured to recognize an object by transmitting and receiving a probe wave or laser light,
the distance measuring sensor information includes a recognition status of the landmark, and
the environment determination unit is configured to determine whether the surrounding environment of the vehicle is the adverse environment based on the recognition result of the target planimetric feature acquired by the image recognition information acquisition unit and the recognition status of the landmark by the distance measuring sensor acquired by the distance measuring sensor information acquisition unit.

13. The adverse environment determination device according to claim 1, wherein
upon determining that the surrounding environment is the adverse environment, the environment determination unit is configured to specify a position of the adverse environment based on at least one of a distance to the recognized target planimetric feature and position information of the vehicle at a timing of determining that the surrounding environment is the adverse environment.

14. The adverse environment determination device according to claim 1, further comprising:
an output unit that is configured to output a signal indicating that the environment determination unit determines that the surrounding environment is the adverse environment.

15. The adverse environment determination device according to claim 1, wherein
the target planimetric feature includes at least one of the lane defining line and a landmark,
the adverse environment determination device further comprises:
a map acquisition unit that is configured to acquire, as the target planimetric feature, map information including position information of at least one of the lane defining line and the landmark, and
the environment determination unit is configured to determine that the surrounding environment is the adverse environment when the target planimetric feature indicated in the map information is not recognized although the target planimetric feature is located within an imaging range of the imaging device.

16. An adverse environment determination method executed by at least one processor for determining whether a surrounding environment of a vehicle is an adverse environment for a device that is configured to perform object recognition using an image, the adverse environment determination method comprising:
acquiring, as image recognition information, information indicative of a recognition result of a target planimetric feature including at least a lane defining line, the image recognition result being determined by analyzing an image captured by an imaging device that is configured to capture the image of a predetermined range of surroundings of a vehicle;
calculating, based on the image recognition information, an actual recognition distance that is an actual distance within which the lane defining line is actually recognized;
determining that the surrounding environment is the adverse environment when the actual recognition distance for the lane defining line is shorter than a predetermined threshold; and
determining a type of the adverse environment based on the actual recognition distance for the lane defining line upon determining that the surrounding environment is the adverse environment.

17. An adverse environment determination method executed by at least one processor for determining whether a surrounding environment of a vehicle is an adverse environment for a device that is configured to perform object recognition using an image, the adverse environment determination method comprising:
acquiring, as image recognition information, information indicative of a recognition result of a target planimetric feature including a landmark, the image recognition result being determined by analyzing an image captured by an imaging device that is configured to capture the image of a predetermined range of surroundings of a vehicle;
determining, based on the image recognition information, an actual recognition distance that is an actual distance within which the landmark is actually recognized;
determining that the surrounding environment is the adverse environment when the actual recognition distance for the landmark is shorter than a predetermined threshold; and
determining a type of the adverse environment based on the actual recognition distance for the landmark upon determining that the surrounding environment is the adverse environment.
